(19) United States
(12) Patent Application Publication
(10) Pub. No.: US 2003/0101253 A1
(43) Pub. Date: May 29, 2003

(54) Method and system for distributing data in a network

(76) Inventors: Takayuki Saito, Tokyo (JP); Masaharu Takano, Kanagawa-ken (JP)

Correspondence Address: HARNESS, DICKEY & PIERCE, P.L.C., P.O. BOX 828, BLOOMFIELD HILLS, MI, 48303, US

(21) Appl. No.: 10/184,415

(22) Filed: Jun. 27, 2002

(30) Foreign Application Priority Data
Nov. 29, 2001 (JP) 2001-364944
Feb. 15, 2002 (JP) 2002-038928

(51) Int. Cl. G06F 15/173

(52) U.S. Cl. 709/223

(57) ABSTRACT

A data distribution method is disclosed which can realize autonomous or private data distribution between user terminals in a network environment such as the Internet. In this method, the respective nodes exchange topology information indicating a connection relationship between upstream nodes and downstream nodes, and relay stream data from the upstream nodes to the downstream nodes. Each node arbitrarily separates from the network and connects to an upstream node in accordance with a predetermined condition.

### CROSS-REFERENCE TO RELATED APPLICATIONS

This application is based upon and claims the benefit of priority from the prior Japanese Patent Applications No. 2001-364944, filed Nov. 29, 2001; and No. 2002-038928, filed Feb. 15, 2002, the entire contents of both of which are incorporated herein by reference.

### BACKGROUND OF THE INVENTION

1. Field of the Invention

The present invention generally relates to a method of distributing data under a network environment and, more particularly, to a technique of implementing a data distribution function between user terminals on the Internet.

2. Description of the Related Art

Recently, in an information communication network environment represented by the Internet, with the progress of broadband communications, it is becoming easy to transmit contents information (to be referred to as stream data hereinafter in some cases) mainly including moving image (video) information and audio information. Broadband network environments include a network environment based on radio communication schemes (mobile communication schemes) such as a scheme using portable telephones as well as ADSL (asymmetric digital subscriber line) transmission schemes and wire communication schemes using CATV (cable television) networks.

User terminals connected to the Internet include personal computers, various digital information devices (e.g., digital TV receivers), portable telephones (including PHSs), portable information devices (also called PDAs: personal digital assistants) having radio communication functions, and the like.

The use of these user terminals under a broadband network environment allows the users to receive stream data and play back contents information such as moving image information and audio information without any sense of incongruity. Conventionally, in information services and individual information exchange through the Internet, character information and still image information are mainly handled, and communication of stream data such as moving image and audio information is limited. With the spreading of broadband network environments, it is expected that distribution of stream data will be made easy not only in the business field including stream data distribution services but also in the private field in which users exchange their private information.

With the progress of broadband communications under network environments, an increase in band and a reduction in communication cost are being attained in trunk systems in the Internet and branch systems that connect to user terminals in homes.

On the other hand, with increasing demands for the distribution of stream data, an increase in load capacity (distribution ability) is required for a system for transmitting stream data. This leads to a demand for an enormous increase in capital investment for servers in particular, and hence an increase in cost required to construct a system.

In general, a stream data distribution system is realized by a server managed by a service company (Internet service provider: ISP or the like). If, therefore, the load capacity of the server cannot be increased on the service company side in terms of cost, an increase in demand for the distribution of stream data cannot be coped with. As a consequence, the Internet band capacity increased with the tendency toward broadband communications cannot be fully used.

In order to solve such a problem, various techniques for decentralized distribution (delivery) of stream data have been developed. With these prior arts, the load on a server which transmits (distributes) stream data can be reduced. However, all the prior arts are basically a scheme in which a server managed by a company provides central control on a decentralized distribution system. Consequently, the load on the server which is associated with the transmission of stream data can be reduced, but the load on the server which is associated with control on a topology (connection relationship between nodes) for constructing a decentralized distribution system increases.

In addition, the scheme of providing central control on a decentralized distribution system is an approach suitable for a service company that distributes stream data by using a server managed by the company. In other words, no technique has been developed that is associated with a decentralized distribution system for realizing autonomous or private distribution of stream data without requiring any server managed by a service company in the private field in which users exchange private information.

### BRIEF SUMMARY OF THE INVENTION

In accordance with one aspect of the present invention, there is provided a method of performing autonomous or private data distribution between user terminals in a network environment such as the Internet.

In a network constructed by a plurality of nodes each including topology management means for managing topology information for recognizing a connection relationship between an upstream node and a downstream node, means for exchanging the topology information between the nodes, and transmission/reception means for data,

the method comprises the steps of:

executing connection between the upstream node and the downstream node;

exchanging the topology information between the upstream node and the downstream node which are connected to each other; and

transmitting the stream data to a downstream node recognized on the basis of the topology information when serving as an upstream node.

### BRIEF DESCRIPTION OF THE SEVERAL VIEWS OF THE DRAWING

FIG. 1 is a view showing the concept of a data distribution system according to the first embodiment of the present invention;

FIG. 2 is a block diagram showing the arrangement of the data distribution system;

FIG. 3 is a block diagram showing the arrangement of a node according to this embodiment;

FIG. 4 is a block diagram showing the arrangement of a topology engine of this node;

FIG. 5 is a block diagram showing the arrangement of a stream engine of this node;

FIG. 6 is a block diagram showing the arrangement of a stream switch section of this node;

FIG. 7 is a block diagram showing the arrangement of a GUI of this node;

FIG. 8 is a flow chart for explaining a procedure for establishing connection between nodes according to this embodiment;

FIG. 9 is a flow chart for explaining a procedure for acquiring an upstream node according to this embodiment;

FIGS. 10A and 10B are flow charts for explaining a topology change procedure according to this embodiment;

FIG. 11 is a flow chart for explaining a procedure for cutting the connection between nodes according to this embodiment;

FIG. 12 is a flow chart for explaining a procedure for processing a downstream node according to this embodiment;

FIG. 13 is a flow chart for explaining a procedure for exchanging topology information between nodes according to this embodiment;

FIG. 14 is a view showing an example of the connection relationship between nodes in a network according to this embodiment;

FIGS. 15A, 15B, and 15C are views showing an example of topology information according to this embodiment;

FIG. 16 is a conceptual view for explaining an authentication method according to the second embodiment;

FIG. 17 is a block diagram showing the arrangement of a system according to this embodiment;

FIG. 18 is a flow chart for explaining a procedure for issuing a public key according to this embodiment;

FIG. 19 is a flow chart for explaining a procedure for issuing a connection key according to this embodiment;

FIG. 20 is a flow chart for explaining an authentication procedure using a connection key according to this embodiment;

FIG. 21 is a flow chart for explaining a procedure for stream relay processing according to this embodiment;

FIG. 22 is a flow chart for explaining a procedure for erasing key data according to this embodiment; and

FIG. 23 is a block diagram for explaining a business model to which this embodiment is applied.

### DETAILED DESCRIPTION OF THE INVENTION

(First Embodiment)

The first embodiment of the present invention will be described below with reference to the views of the accompanying drawing.

(Basic Arrangement of System)

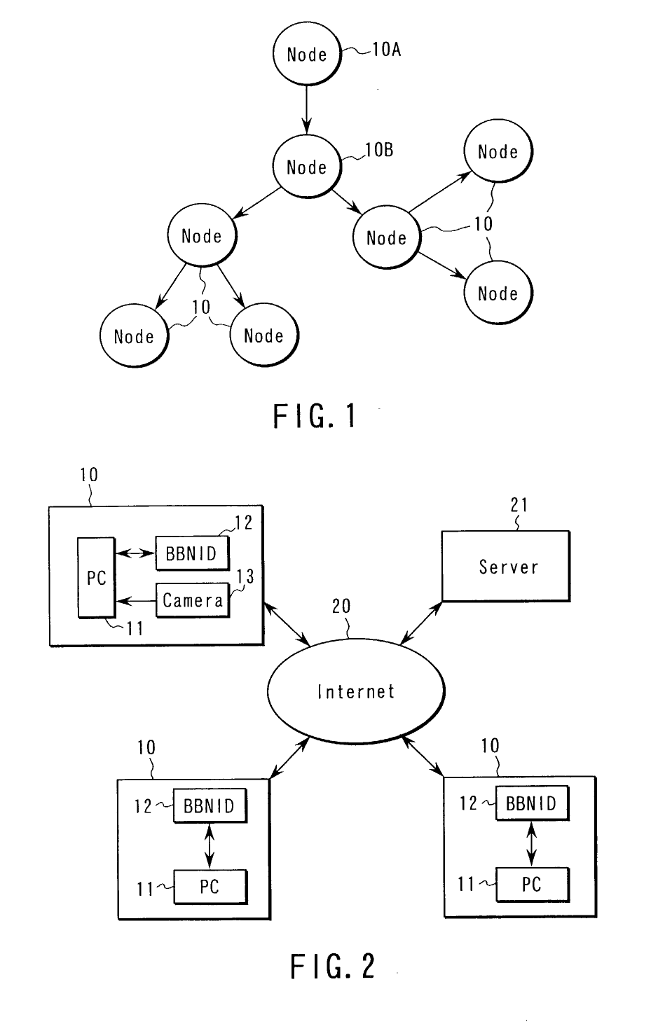

FIG. 1 is a view showing the concept of a data distribution system according to this embodiment.

This system is assumed to be used in an always-on connection type high-speed network environment such as the broadband Internet, in particular, and designed to distribute, for example, stream data through a plurality of nodes 10 connected to the network.

In this case, the stream data means continuous digital data such as moving image (video) data and audio data. The node 10 is generally a user terminal connected to the network but may be a network device such as a server or router. The user terminal specifically means a personal computer, a portable information terminal (e.g., a PDA or notebook personal computer) having a radio communication function, or a digital information device such as a cellar telephone (including a PHS). The user terminal may also means a system formed by connecting a plurality of devices through a LAN or wireless LAN as well as the above single device.

In this system, a node 10B which has received the stream data transmitted from a given node 10A plays back (watches/listens) the stream data by decoding it, and relays it to other nodes 10. In this case, the node B relays the stream data to a plurality of nodes 10 within the throughput and allowable network connection band range.

In brief, this system realizes a stream data decentralized distribution function of distributing stream data to many user terminals by relaying the data from an upstream node to downstream nodes without requiring any high-performance distribution server. In this case, the upstream node is a stream data source node or relay node located upstream from the local node. The downstream nodes are stream data destination nodes when viewed from the local node. The downstream nodes are reception nodes that receive the stream data, and also are relay nodes that further transmit the data to downstream nodes.

FIG. 2 is a block diagram showing an example of the specific arrangement of this system.

More specifically, this system is designed such that in a network constructed by connecting many nodes 10 as user terminals to an Internet 20, stream data is distributed to each user terminal that has joined in a stream data decentralized distribution system. Each node 10 is designed in consideration of an environment in which it is connected to the Internet through an always-on connection type high-speed line by using, for example, the ADSL transmission scheme or CATV network.

A given node 10 is a user terminal including, for example, a PC (Personal Computer) 11 and BBNID (Broad-Band Network Interface Device) 12. More specifically, the BBNID 12 is a network device obtained by integrating, for example, an ADSL modem or cable modem (CATV Internet Modem) and a router function. This node 10 plays back the stream data received through the Internet 20 on, for example, the display of the PC 11 and relays the data to other downstream nodes 10.

A given node 10 has the PC 11 and a digital video camera (DVC) 13. This node 10 is a user terminal that serves as an upstream node and transmits stream data formed from video data (including audio data) obtained by the DVC 13 by using software (a main constituent element of this embodiment) set in the PC 11.

(Arrangement of Node)

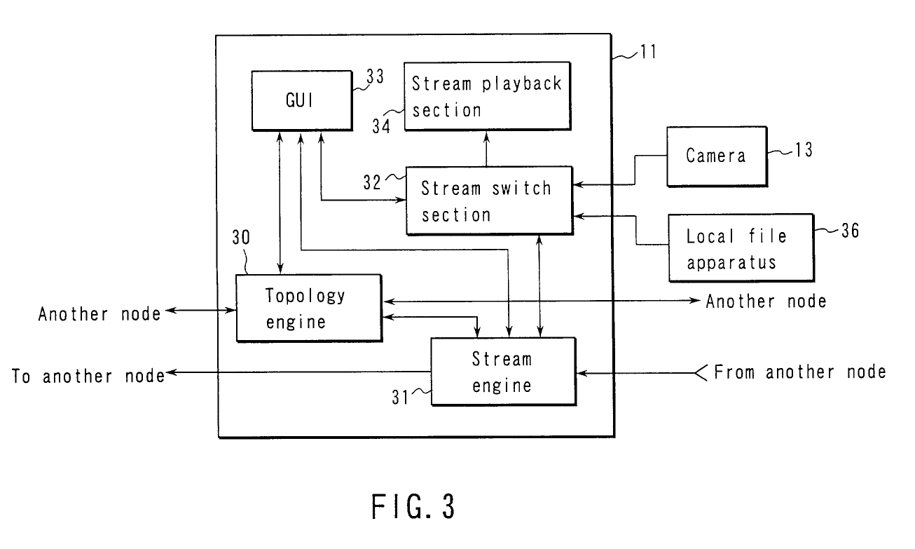

The arrangement of the node 10 serving as a user terminal according to this embodiment will be described next with reference to FIG. 3.

The node 10 according to this embodiment is comprised of, for example, a personal computer, software set in the computer, and various devices. FIG. 3 is a block diagram showing the software configuration that is a main constituent element of the embodiment and operates in the PC 11.

All the nodes 10 constituting the stream data decentralized distribution system have the identical software configurations to implement stream data transmission, reception, relay, and playback functions. Each element of the software configuration will be described in detail below. Note that the software configuration of this embodiment is not dependent on a specific OS (Operating System).

This software configuration is comprised of a topology engine 30, a stream engine 31, a stream switch section 32, a GUI (Graphical User Interface) 33 for controlling the overall operation environment for the node, and a stream playback section 34.

In general, the topology engine 30 implements the function of establishing a network connection relationship (topology) among the respective nodes 10 by exchanging messages (control information). More specifically, the topology engine 30 connects the respective nodes 10 to each other through TCP/IP (Transmission Control Protocol/Internet Protocol) to transmit/receive various messages. The topology engine 30 also recognizes the existence of a neighboring node, which is directly or indirectly connected to the local node, through the exchange of messages. The topology engine 30 obtains an alternate topology from the existence information of the neighboring node and the reception state of stream data, and changes the established connection relationship among the respective nodes in accordance with the topology.

The stream engine 31 is software for implementing the functions of transmitting, receiving, and relaying stream data between the nodes 10. The stream engine 31 transmits stream data to one or a plurality of downstream nodes as adjacent nodes on the basis of the topology information (topology information table to be described later) received from the topology engine 30. The stream engine 31 receives stream data from one or a plurality of nodes as adjacent nodes.

In this case, the adjacent node means a downstream or upstream node that is directly connected to the local node. The neighboring node means an upstream or downstream node that is indirectly connected to the local node. The topology information (topology information table) includes information indicating the logical connection relationship between the respective nodes (information for identifying “upstream”/“downstream” and “adjacent”/neighboring”) and information specifying an adjacent or neighboring node with which the connection relationship is formed (a network address or the like) (see FIGS. 15A to 15C).

The stream engine 31 establishes TCP/IP connection for stream data transmission/reception, and executes transmission/reception of stream data between the respective nodes. The stream engine 31 has a general-purpose distribution function independent of the data format (encoding scheme) of stream data, and can be applied to various data formats such as a format conforming to MPEG specifications.

The stream switch section 32 is software for implementing the function of linking the stream engine 31 to other functions, devices, and files. The main function of the stream switch section 32 is to activate the stream playback section 34 and transfer the stream data extracted from the stream engine 31 to the stream playback section 34. The stream playback section 34 is software for decoding the stream data into video and audio data to be output and playing it back. The stream switch section 32 also implements the function of extracting stream data from the digital video camera (DVC) 13 or a local file apparatus 36 and transferring it to the stream engine 31 so as to transmit it to other nodes.

The GUI 33 provides an interface between the user and topology engine 30, stream engine 31, and stream switch section 32. More specifically, the GUI 33 visibly displays the topology (connection relationship) between the local node and an adjacent or neighboring node and visibly displays the amount of data communicated by the stream engine 31. The GUI 33 also sets an explicit connection request for another node or a connection key for the local node in accordance with a command input from the user. The connection key is key data used for an authentication function associated with the connection between nodes and included in the topology engine 30.

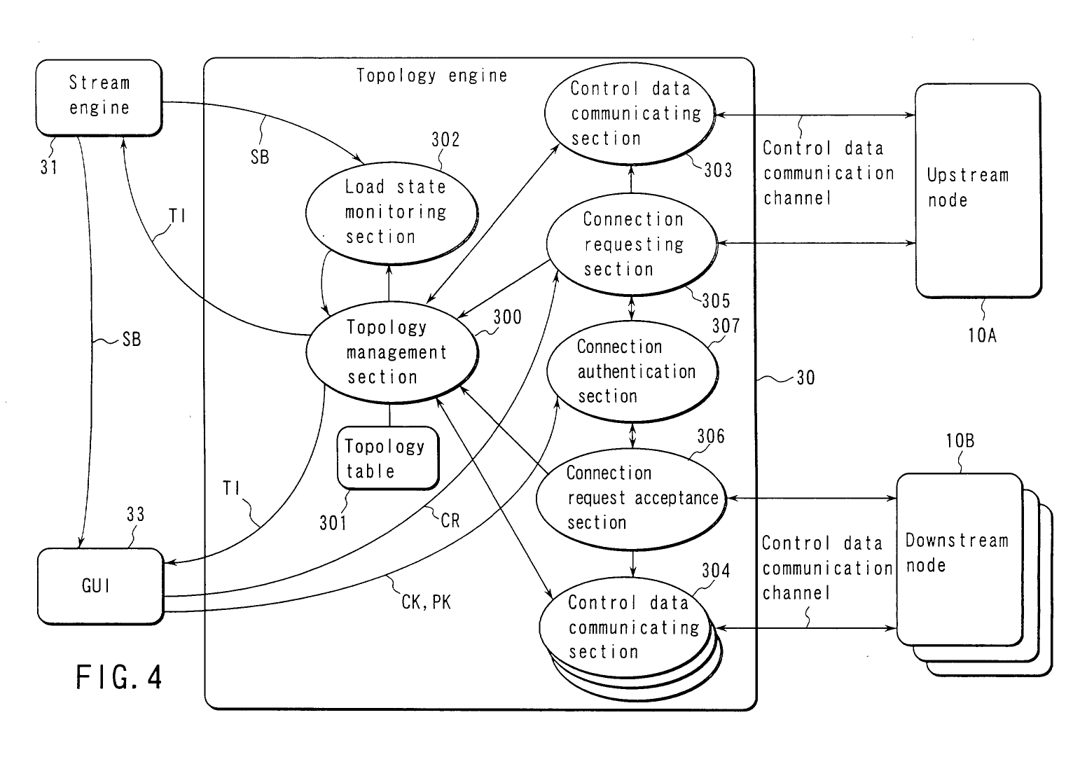

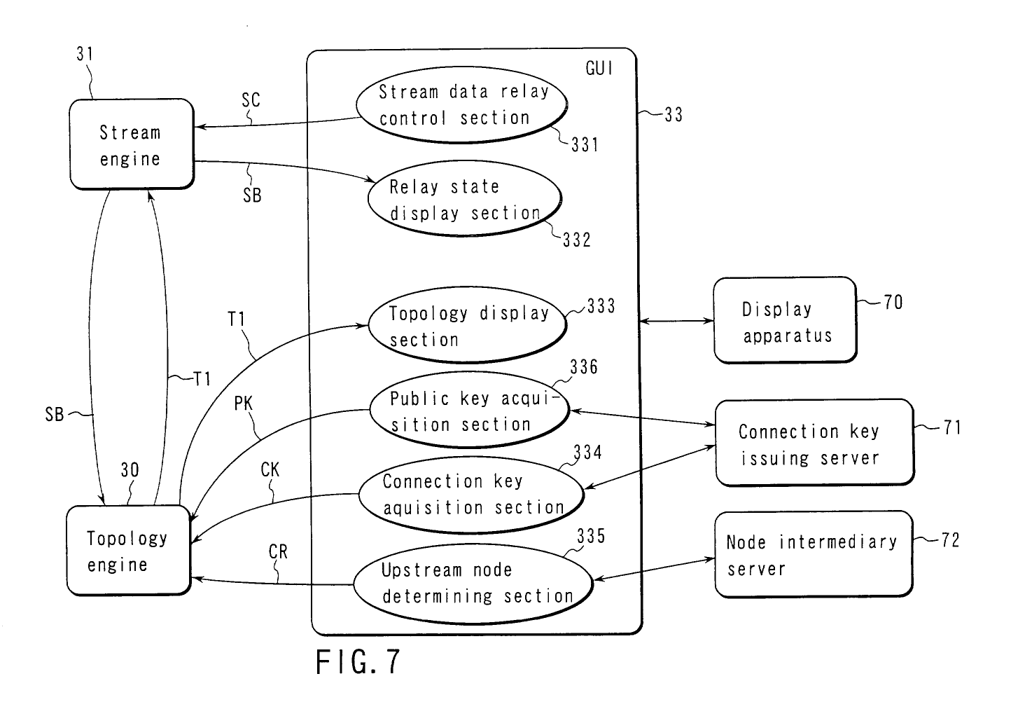

The authentication function using a connection key (CK) and public key (PK) will be described in detail below. Assume that a given node serves as a distribution source (distribution server). In this case, as will be described later, a public key acquisition section 336 of the GUI 33 acquires the public key (PK) from a connection key issuing server 71. A connection authentication section 307 of the topology engine 30 receives and stores this key (see FIGS. 4 and 7). The connection authentication section 307 performs authentication by decrypting the connection key (CK) using the public key (PK) in accordance with an authentication request (including the connection key CK) from a connection request acceptance section 306.

On the other hand, a node that will join in as a viewer acquires the connection key (CK) from the connection key issuing server 71 to which a connection key acquisition section 334 of the GUI 33 is connected. The connection authentication section 307 of the topology engine 30 receives and stores this key. In sending a connection request to an upstream node, a connection requesting section 305 of the topology engine 30 receives the connection key (CK) from the connection authentication section 307 and sends the connection request to the upstream node.

Each software configuration of the node 10 will be described in more detail below.

(Topology)

As shown in FIG. 4, the topology engine 30 has the following functional element sections: a topology management section 300, topology table 301, load state monitoring section 302, control data communicating sections 303 and 304, connection requesting section 305, connection request acceptance section 306, and connection authentication section 307.

The topology management section 300 recognizes the existence of an adjacent node group or neighboring node group and the connection relationship (topology) between the nodes on the basis of the topology information (TI) received from an upstream node to which the local node is directly connected. The topology management section 300 stores a topology information table conforming to the table format of the topology information (TI) in the topology table 301 (TI will be written as an information table in some cases). The topology management section 300 updates the information table (TI) stored in the topology table 301 in accordance with a change in the topology between the nodes.

The topology management section 300 transfers the node identifiers (network addresses) of adjacent nodes to which the local node is directly connected, i.e., an upstream node (a single node in general) and one or a plurality of downstream nodes, to the stream engine 31. The stream engine 31 establishes TCP/IP connection for stream data transmission/reception between the local node and the adjacent nodes. The topology management section 300 also transfers the information table (TI) stored in the topology table 301 to the GUI 33. The GUI 33 visualizes the topology between the nodes on the basis of the information table (TI) and displays it on the screen (see FIG. 7).

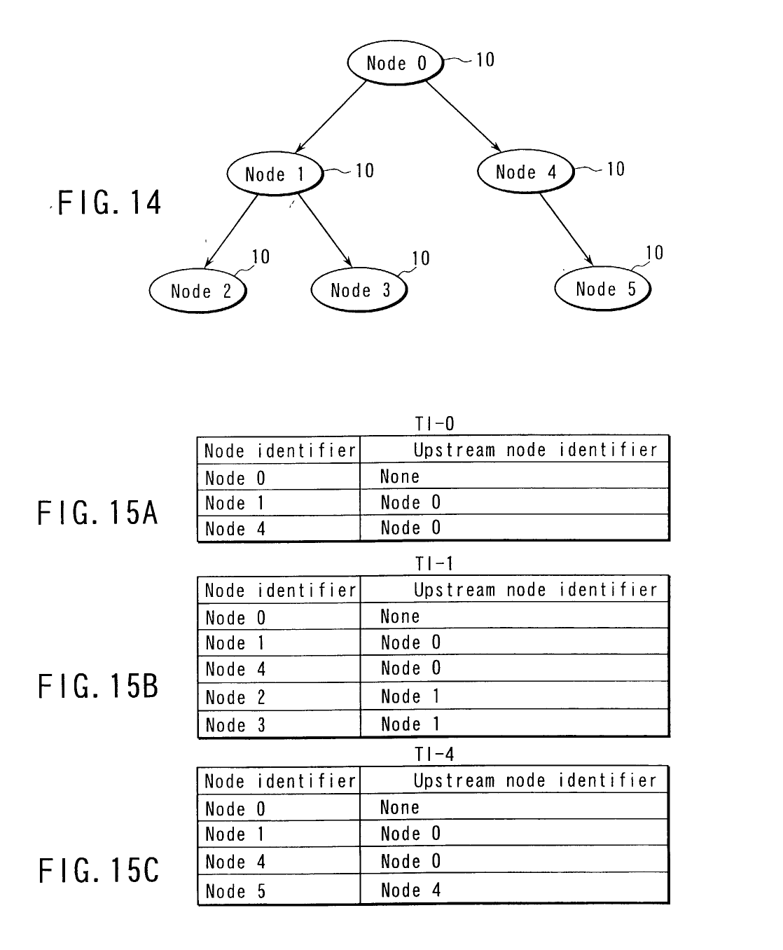

Topology information table (TI) will be described in detail below with reference to FIG. 14 and FIGS. 15A to 15C.

FIG. 14 is a view showing an example of the connection relationship (topology) between the respective nodes 10 on the network. The respective nodes 10 are specified by identifiers (node0 to node5) corresponding to, for example, network addresses. Basically, the local node 10 receives topology information (TI) from an upstream node, and registers it as the topology table 301. In accordance with a connection request from a downstream node, each node 10 provides the downstream node with the topology information (TI) to which the connection relationship with the downstream node is added.

Assume that the node 10 with node0 provides downstream nodes (node1 and node4) with topology information (TI-0) recording the connection relationship with the downstream nodes (node1 and node4). As shown in FIG. 15A, this topology information (TI-0) is an information table in which the node identifies (node0, node1, and node4) with which the local node has a connection relationship are made to correspond to the identifier of the upstream node (only node0) as an adjacent node (to which the local node is directly connected). Note that flag information indicating a downstream node may be added to each of the identifiers (node1 and node4) of the downstream nodes. With this flag information, the local node (node0) can recognize the identifiers (node1 and node4) registered in the topology information (TI-0) as downstream nodes which are adjacent nodes.

As shown in FIG. 14, the downstream node (node1) assumes that the local node has established, serving as an upstream node, a connection relationship with the downstream nodes (node2 and node3). In this case, the downstream node (node1) generates topology information (TI-1) by adding this connection relationship to the topology information (TI-0) provided from the upstream node (node0), and provides the information to the downstream nodes (node2 and node3) (see FIG. 15B). Likewise, flag information indicating a downstream node may be added to each of the identifiers (node2 and node3) of the downstream nodes.

In this case, connection relationships (1) to (3) can be recognized by node2 from the provided topology information (TI-1). More specifically, as connection relationship (1), the existence of the downstream node (node3) as an adjacent node to the upstream node (node1) can be recognized other than the local node. As connection relationship (2), the existence of the upstream node (node0) relative to the upstream node (node1) with respect to the local node can be recognized. As connection relationship (3), the existence of the downstream node (node4) relative to the upstream node (node0) can be recognized. These nodes with node0, node3, and node4 to which the local node (node2) is indirectly connected are neighboring nodes for the local node.

Likewise, the downstream node (node3) can recognize connection relationships (1) to (3) from the provided topology information (TI-1). More specifically, as connection relationship (1), the existence of the downstream node (node2) as an adjacent node to the upstream node (node1) can be recognized other than the local node. As connection relationship (2), the existence of the upstream node, (node0) relative to the upstream node (node1) with respect to the local node can be recognized. As connection relationship (3), the existence of the downstream node (node4) relative to the upstream node (node0) can be recognized.

As shown in FIG. 14, the downstream node (node4) assumes that the local node has established, serving as an upstream node, a connection relationship with the downstream node (node5). In this case, the downstream node (node4) generates topology information (TI-4) by adding this connection relationship to the provided topology information (TI-0), and provides the information to the downstream node (nodes) (see FIG. 15C). Likewise, flag information indicating a downstream node may be added to the identifier (node5) of the downstream node.

In summary, each node can recognize the existence of adjacent and neighboring nodes by managing (e.g., registering, updating, and providing) the topology information (TI) basically provided from upstream to downstream as the topology table 301. As described above, an adjacent node is an upstream or downstream node that is directly connected to the local node. A neighboring node is a node that is indirectly connected to the local node (the neighboring node is not necessarily located upstream or downstream from the local node).

Note that the topology information (TI) increases in information amount toward downstream. For this reason, the topology management section 300 is preferably designed to delete the information (identifier and the like) of a node with which the local node has the remotest relationship when the predetermined upper limit of information amount is exceeded.

As shown in FIG. 4, the load state monitoring section 302 monitors the storage state (SB) of the stream data buffer (FIFO buffer) of the stream engine 31 (to be described later) to determine the load state of the stream engine 31. If the load state of the stream engine 31 exceeds an allowable range, the load state monitoring section 302 instructs the topology management section 300 to disconnect a downstream node. As will be described later, the GUI 33 is also notified of the storage state (SB) of the stream data buffer of the stream engine 31.

In accordance with an instruction from the connection requesting section 305, the control data communicating section 303 establishes a control data communication channel to the upstream node 10A. The upstream node 10A corresponds to a stream data source node when viewed from the local node 10. The control data communicating section 303 receives topology information (TI) from the upstream node 10A. When switching the upstream node 10A to another node, the control data communicating section 303 disconnects the control data communication channel.

The control data communicating section 304 establishes a control data communication channel to the downstream node 10B in accordance with an instruction from the connection request acceptance section 306. The downstream node 10B corresponds to a destination node to which stream data is transmitted from the local node. The control data communicating section 304 transmits topology information (TI) to the downstream node 10B. When the downstream node 10B switches the upstream node from the local node to another node, the control data communicating section 304 disconnects the control data communication channel.

In accordance with designation (CR) of an upstream node from the GUI 33, the connection requesting section 305 transmits a connection request to the upstream node 10A. In addition, the connection requesting section 305 instructs the control data communicating section 303 to establish connection in accordance with a connection acceptance notification from the upstream node 10A to which the connection request has been transmitted. At this time, the connection requesting section 305 instructs the topology management section 300 to register the network address of the upstream node 10A with which a control data communication channel has been established. Upon transmitting the connection request, the connection requesting section 305 exchanges connection key data (CK) and public key data (PK) required for connection authentication processing with the upstream node 10A as a connection target.

In accordance with the connection request from the downstream node 10B, the connection request acceptance section 306 accepts connection when authentication is made by the connection authentication section 307. In accordance with the connection acceptance, the connection request acceptance section 306 instructs the control data communicating section 304 to make connection and also instructs the topology management section 300 to register the network address of the downstream node 10B with which a control data communication channel has been established. Upon the connection acceptance, the connection request acceptance section 306 exchanges connection key data (CK) and public key data (PK) required for connection authentication processing with the downstream node 10B as a connection target. Note that a connection authentication procedure will be described later.

The connection authentication section 307 executes connection authentication processing required for connection to other nodes (upstream and downstream nodes) which is made by the connection requesting section 305 and connection request acceptance section 306. The connection authentication section 307 executes authentication processing by using a public key cryptography, and receives connection key data (CK) and public key data (PK) corresponding to a certification ticket from the GUI 33. The connection authentication section 307 also exchanges connection key data (CK) and public key data (PK) with the connection requesting section 305 and connection request acceptance section 306.

Assume that a given node serves as a distribution source (distribution server), as described above. In this case, the public key acquisition section 336 of the GUI 33 acquires public key data (PK) from the connection key issuing server 71. The connection authentication section 307 of the topology engine 30 receives and stores this data. In accordance with an authentication request (including connection key data (CK)) from the connection request acceptance section 306, the connection authentication section 307 performs authentication by decrypting the connection key data (CK) by using the public key data (PK) in accordance with an address request. In a node that will join in as a viewer, the connection key acquisition section 334 of the GUI 33 acquires connection key data (CK) from the connection key issuing server 71. The connection authentication section 307 of the topology engine 30 receives and stores this data. In sending a connection request to an upstream node, the connection requesting section 305 of the topology engine 30 receives connection key data (CK) from the connection authentication section 307 and sends the connection request to the upstream node.

(Stream Engine)

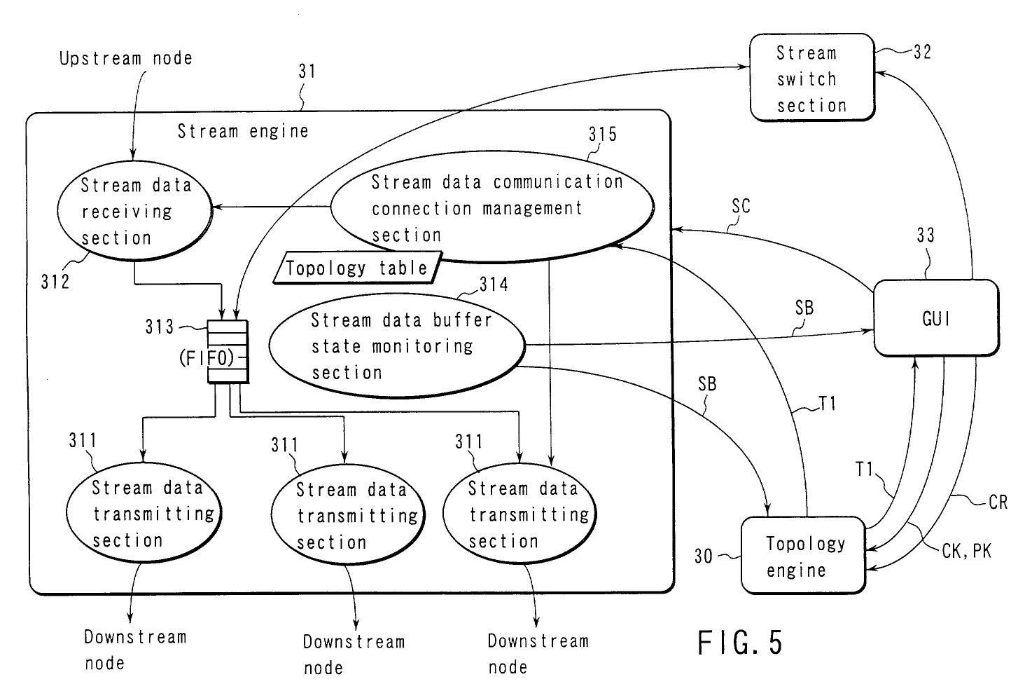

As shown in FIG. 5, the stream engine 31 includes the following functional element sections: a stream data transmitting section (data transmitter) 311, stream data receiving section (data receiver 312) 312, stream data buffer (data buffer) 313, stream data buffer state monitoring section (buffer monitor) 314, and stream data communication connection management section (connection controller) 315.

The data transmitter 311 transmits (relays) the stream data stored in the data buffer 313 to a downstream node. At this time, the data transmitter 311 transmits the stream data to a downstream node for which an instruction to permit connection is given by the connection controller 315.

The data buffer 313 is a FIFO buffer for temporarily storing stream data from an upstream node which is received by the data receiver 312 or the stream data received from the stream switch section 32. The data monitor 314 always monitors the storage state (SB) of the data buffer 313 and notifies the topology engine 30 and GUI 33 of the monitored state. In this case, the storage state (SB) means the amount of stream data stored in the data buffer 313 with respect to its size.

The data receiver 312 establishes a stream data communication channel to the upstream node designated by the connection controller 315. The data receiver 312 then receives stream data from the upstream node and writes the data in the data buffer 313. The connection controller 315 receives a list of adjacent nodes with which connection relationships should be established through stream data communication channels from the topology engine 30.

(Stream Switch Section)

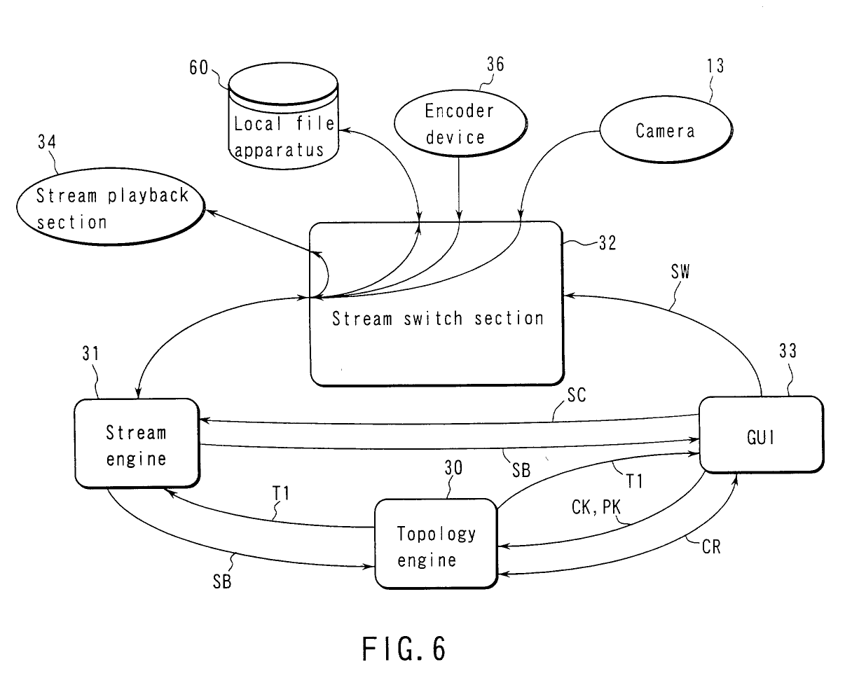

As shown in FIG. 6, the stream switch section 32 performs input/output switching of stream data in accordance with an instruction (SW) from the GUT 33. More specifically, the stream switch section 32 transfers the stream data received from the stream engine 31 to the stream playback section 34 or a local file apparatus 60 of the node. In addition, the stream switch section 32 receives stream data from a digital video camera (DVC) 35 or encoder device 36 or reads out stream data from the local file apparatus 60 and transfers the data to the stream engine 31.

(GUI)

As shown in FIG. 7, the GUT 33 includes the following functional element sections: a stream data relay control section 331, a relay state (quality) display section 332, a topology display section 333, the connection key acquisition section 334, an upstream node determining section 335, and the public key acquisition section 336. The GUT 33 inputs a command corresponding to operation with respect to an icon on the display screen of a display apparatus 70, and displays various display information on the display screen.

The stream data relay control section 331 gives the stream engine 31 an instruction (SC) to stop or resume stream data relay operation in accordance with a command input from a user. The relay state (quality) display section 332 reads the storage state (SB) of the data buffer 313 from the stream engine 31 and executes processing for displaying the state on the display screen.

The topology display section 333 receives topology information (TI) from the topology engine 30 and executes processing for displaying the connection relationship with an adjacent or neighboring node on the display screen. The connection key acquisition section 334 transfers to the topology engine 30 the connection key data (CK) input from the user or the connection key data (CK) issued from the connection key issuing server 71 (to be described later). In sending a connection request to an upstream node, the connection requesting section 305 of the topology engine 30 receives connection key data (CK) from the connection authentication section 307 and sends a connection request to the upstream node.

When a given node serves as a distribution source (distribution server), the public key acquisition section 336 of the GUI 33 acquires public key data (PK) from the connection key issuing server 71 and transfers the data to the connection authentication section 307 of the topology engine 30. In accordance with an authentication request (including connection key data (CK)) from the connection request acceptance section 306, the connection authentication section 307 performs authentication by decrypting the connection key data (CK) by using the public key data (PK).

The upstream node determining section 335 transfers the network address of the upstream node designated by the user or the upstream node from by a node intermediary server 72 to the topology engine 30.

(Connection Establishment Procedure)

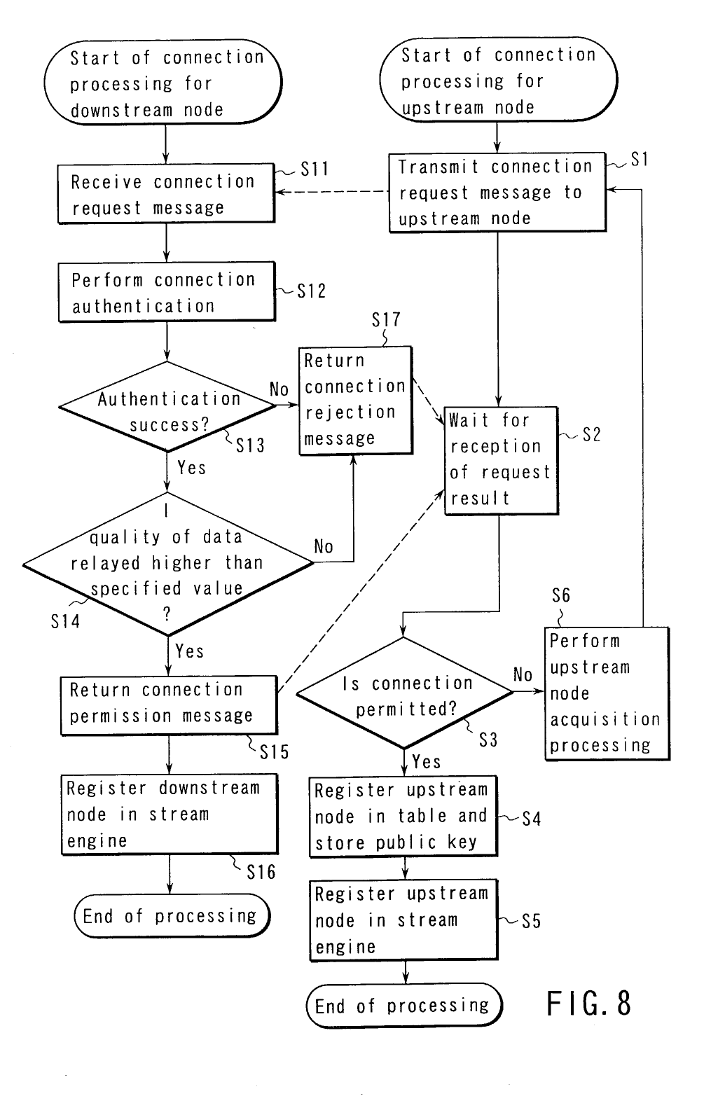

A procedure for connection processing between nodes in this embodiment will be described below with reference to FIG. 8.

Connection processing between nodes can be divided into connection processing for a downstream node viewed from the local node in FIG. 8 and connection processing for an upstream node viewed from the local nod in FIG. 8. That is, the local node executes connection processing for an upstream or downstream node in terms of a relative relationship.

In performing connection processing for an upstream node, the topology engine 30 of the local node transmits a connection request message to the upstream node (step S1). More specifically, the connection requesting section 305 in FIG. 4 transmits a connection request message containing connection key data and ID data. For example, the ID data includes a group ID aimed at constructing a specific network for stream data distribution or a contents ID set for each content of stream data. The ID data also includes ID data for identifying the hardware of each node (e.g., the MAC address of a network interface or the serial number assigned to a microprocessor).

The local node is kept in a standby state until a reply to the connection request (connection authentication result) is received from the upstream node (step S2). Upon reception of a message indicating connection permission from the upstream node, the topology engine 30 establishes a control communication channel to the upstream node, and registers the upstream node in the topology table 301 (step S4). The topology engine 30 stores the public key data contained in the message indicating connection permission received from the upstream node. The topology engine 30 also causes the stream engine 31 to register the connected upstream node (step S5). With this operation, the stream engine 31 connects a stream data communication channel to the upstream node and sets a state wherein stream data can be received.

Upon reception of a message indicating connection rejection from the upstream node, the local node can shift to processing of attempting to connect to another upstream node (NO in step S3; step S6). In this case, another upstream node means an upstream node required for the local node to receive the distribution of desired stream data. This upstream node belongs to the same group that forms a stream data decentralized distribution network (to be described later).

Connection processing for a downstream node, i.e., connection processing in a case wherein the local node relatively serves as an upstream node, will be described next with reference to the flow chart of FIG. 8.

Upon reception of a connection request message containing connection key data from a downstream node, the local node executes connection authentication processing (steps S11 and S12). The connection authentication section 307 of the topology engine 30 executes connection authentication processing by decrypting the connection key by using the public key data acquired in advance. If the authentication fails, the connection authentication section 307 returns a connection rejection message to the downstream node (NO in step S13; step S17).

If the authentication succeeds, the topology engine 30 checks whether the quality of stream data relayed to the existing downstream node is equal or more than a specified value. If the determination result indicates that the quality is less than the specified value, the topology engine 30 returns a connection rejection message to the downstream node (NO in step S14; step S17). That is, if the quality of data relayed becomes less than the specified value when a new downstream node is connected, the local node rejects connection to prevent an increase in the number of downstream nodes.

When finally permitting connection, the topology engine 30 returns a connection permission message containing public key data to the downstream node (YES in step S14; step S15). The topology engine 30 also registers the downstream node to which the connection permission has been given in the topology table 301, and causes the stream engine 31 to register the downstream node (step S16). With this operation, the stream engine 31 connects a stream data communication channel to the downstream node and becomes able to transmit stream data.

With the above connection processing, connection is established between the respective nodes, i.e., upstream and downstream nodes, and a network for a stream data decentralized distribution system can be constructed, as shown in FIG. 1.

(Upstream Node Acquisition Procedure)

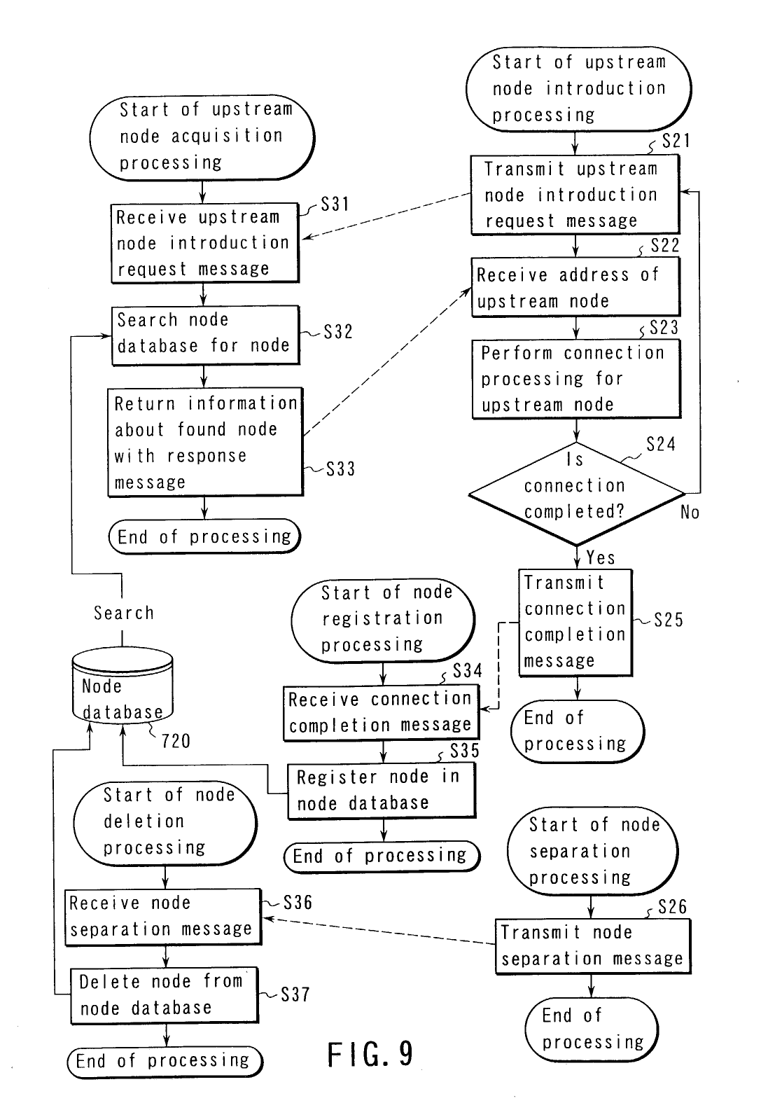

A procedure for newly acquiring an upstream node to allow the local node to receive the distribution of stream data, i.e., join in a stream data decentralized distribution system, will be described below with reference to FIG. 9. In this case, steps S21 to S26 shown in FIG. 9 indicate a procedure on each node side. Steps S31 to S37 shown in FIG. 9 indicate a procedure on the node intermediary server side.

Assuming the existence of a node intermediary server (server 72 in FIG. 7), an arrangement for receiving the introduction of an upstream node from the node intermediary server will be described below.

The node intermediary server has registered a plurality of nodes corresponding to a group ID, i.e., belonging to one stream data decentralized distribution system, in a node database 720. Obviously, nodes respectively belonging to a plurality of group IDs (stream data decentralized distribution systems) can be registered in the node database 720.

First of all, the local node transmits an upstream node introduction request message (containing a group ID) to the node intermediary server (step S21). Upon reception of the message, the node intermediary server searches the node database 720 for a node belonging to the stream data decentralized distribution system (steps S31 and S32). The node intermediary server then returns a response message containing the network address of the found node (step S33).

The local node acquires the network address of the introduced upstream node from the response message, and shifts to connection processing for the upstream node (steps S22 and S23). Step S23 is the processing step started from step S1 in FIG. 8. In this connection processing, as described above, the introduced upstream node executes connection authentication processing to finally determine connection permission or connection rejection. If connection to the upstream node is not completed, the local node transmits an introduction request to the node intermediary server again (NO in step S24; step S21).

When connection to the upstream node is completed, a connection completion message is transmitted to the node intermediary server (YES in step S24; step S25). Upon reception of the message, the node intermediary server registers the local node in the node database 720 (steps S34 and S35). Upon reception of a node separation message indicating separation from the stream data decentralized distribution system from the local node, the node intermediary server deletes the registration of the local node from the node database 720 (steps S26, S36, and S37).

With the above processing, a user who wants to join in a stream data decentralized distribution system can connect to an upstream node which can relay stream data. Note that if the network address of an upstream node can be acquired by a different method without the mediacy of the node intermediary server, the user can connect to the upstream node.

(Topology Change Procedure)

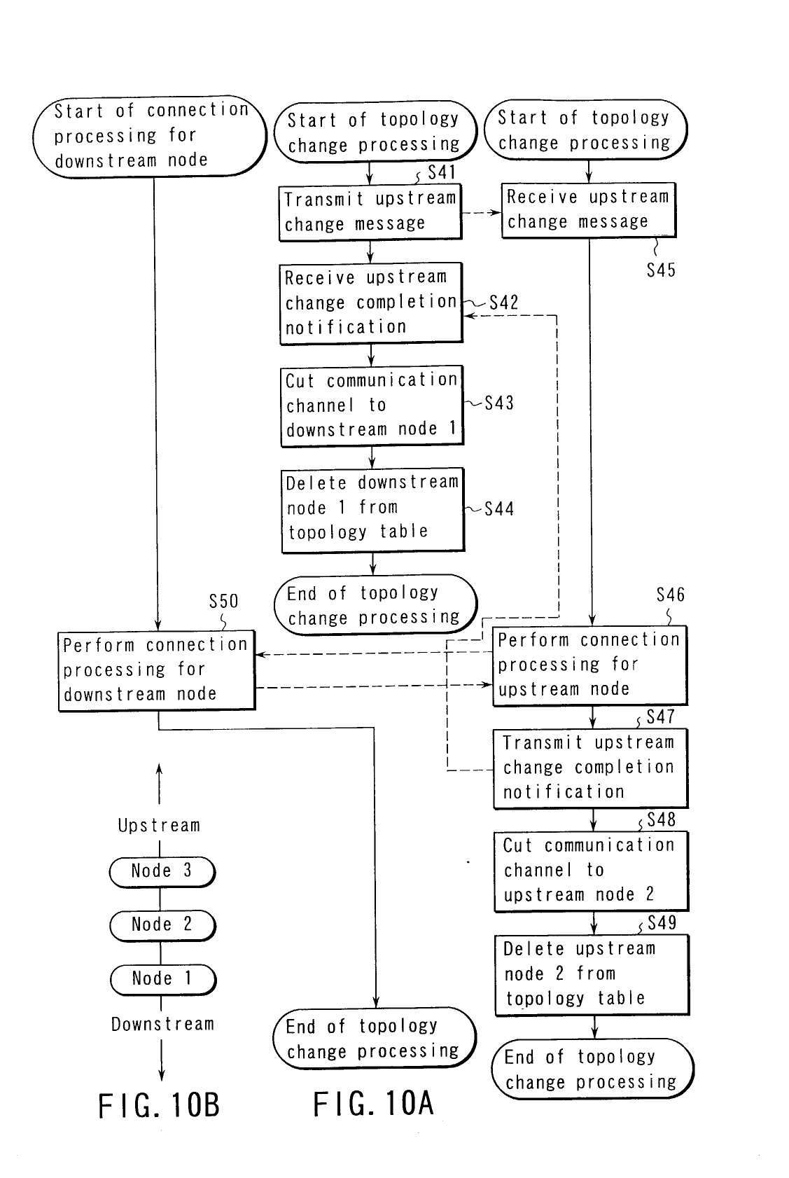

A procedure for changing a topology as a connection relationship in a stream data decentralized distribution system constructed by connecting nodes will be described below with reference to FIGS. 10A to 10D.

Assume a topology in a state wherein nodes (1) and (2) on the relatively downstream side and node (3) on the upstream side are connected to each other as shown in FIG. 10B. As shown in FIG. 10A, node (2) executes upstream node change processing with respect to node (1) as topology change processing. That is, node (2) transmits an upstream node change message containing the designation of alternate upstream node (3) to downstream node (1) (step S41).

As shown in FIG. 10B, upon reception of the upstream node change message from upstream node (2), downstream node (1) executes connection processing for designated alternate upstream node (3) (steps S45 and S46). In the connection processing, downstream node (1) transmits a connection request message to alternate upstream node (3). As shown in FIG. 10B, alternate upstream node (3) executes connection processing for downstream node (1) on the basis of the received connection request message (step S50). Alternate upstream node (3) returns a connection permission message or connection rejection message to downstream node (1). Note that steps S46 and S50 correspond to processing steps started from steps S1 and S11 in FIG. 8.

Upon reception of a connection permission message from alternate upstream node (3), downstream node (1) transmits an upstream change completion notification to upstream node (2) (step S47). Downstream node (1) disconnects the communication channels (control data communication channel and stream data communication channel) from upstream node (2), and deletes the registration of upstream node (2) from the topology table 301 (steps S48 and S49).

Upon reception of the upstream change completion notification, upstream node (2) disconnects the communication channels (control data communication channel and stream data communication channel) from downstream node (1), and deletes the registration of downstream node (1) from the topology table 301 (steps S42, S43, and S44).

With the above upstream change processing, the connection relationship between the upstream node and the downstream nodes is changed. As a consequence, the topology as the connection relationship between the respective nodes can be changed. This topology change function is effective when, for example, node (2) separates from the network or node (3) newly joins in the network. That is, downstream node (1) can dynamically and autonomously change an upstream node in accordance with the state of each node, and hence can receive stream data without interruption.

(Disconnection Procedure)

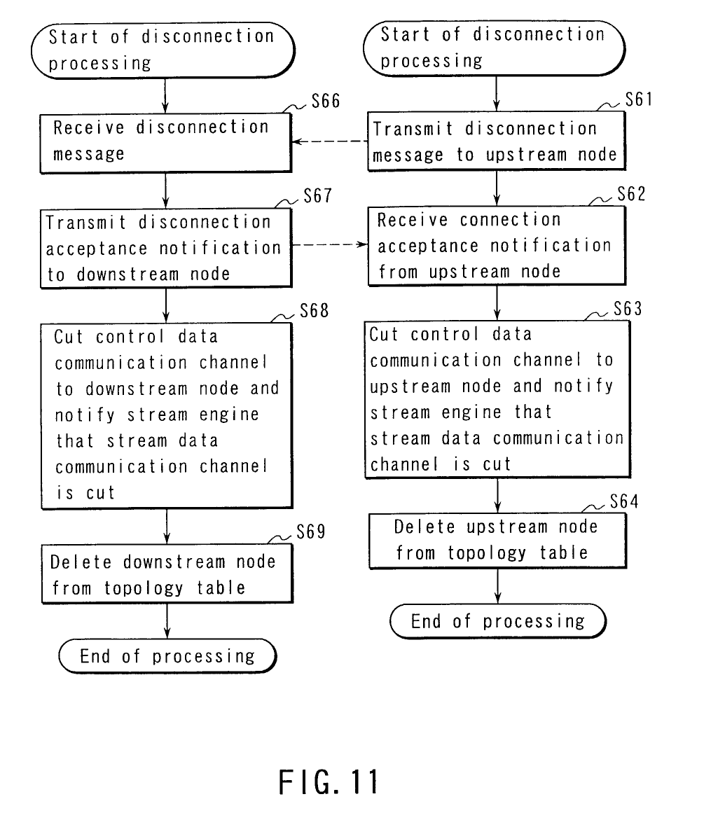

A procedure for disconnection processing between nodes in this embodiment will be described below with reference to FIG. 11. A procedure by which a downstream node cuts connection to an upstream node will be described below. Basically the same procedure is done in the reverse case.

First of all, as shown in FIG. 11, the downstream node transmits a disconnection message to the upstream node to which the downstream node is connected (step S61). As shown in FIG. 11, upon reception of the disconnection message, the upstream node transmits a disconnection acceptance notification to the downstream node (steps S66 and S67).

Upon reception of the disconnection acceptance notification from the upstream node, the downstream node disconnects the communication channels (control data communication channel and stream data communication channel) from the upstream node (steps S62 and S63). In addition, the downstream node deletes the registration of the upstream node from the topology table 301 (step S64)

On the other hand, the upstream node disconnects the communication channels (control data communication channel and stream data communication channel) from the downstream node (step S68). The upstream node also deletes the registration of the downstream node from the topology table 301 (step S69).

With the above disconnection processing, each node can cut the connection to a given node in a connection relationship at an arbitrary timing. With this disconnection processing, the topology between the respective nodes is changed.

(Procedures in Downstream Node)

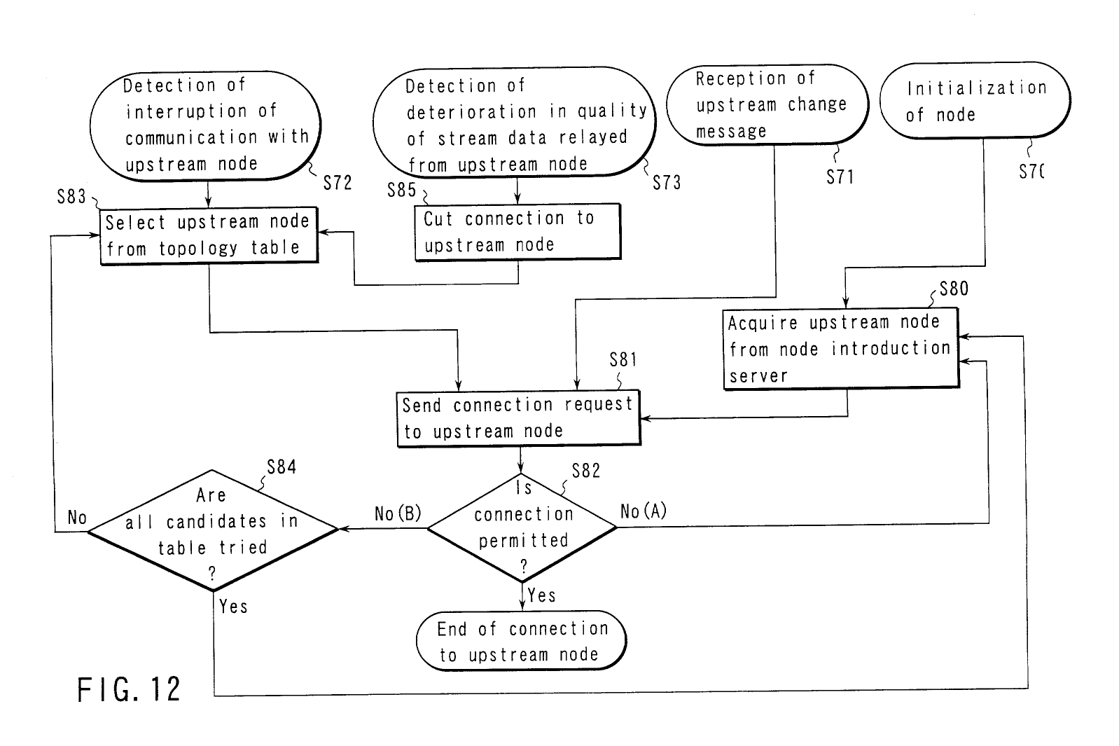

FIG. 12 is a flow chart for systematically explaining the procedures on the downstream node side.

When a user is to join in a stream data decentralized distribution system, the user terminal executes, as a downstream node, initialization processing (step S70). More specifically, as described above, an upstream node is introduced from the node intermediary server (step S80). The downstream node sends a connection request to the introduced upstream node (step S81). If a connection permission notification is received from the upstream node, the connection to the upstream node is completed (YES in step S82). This allows the downstream node to receive stream data from the introduced upstream node.

Upon reception of an upstream change message from the connected upstream node (step S71), the downstream node sends a connection request to the alternate upstream node contained in the message (step S81). If the downstream node receives a connection permission notification from the alternate upstream node in response to this connection request, the connection to the upstream node is completed (YES in step S82). In this case, if the downstream node receives a connection rejection notification from the alternate upstream node or cannot obtain any response, a new upstream node is introduced from the node intermediary server (NO (A) in step S82; step S80).

If the downstream node detects an interruption of communication (including disconnection of a communication channel) with the connected upstream node (step S72), the downstream node selects another upstream node from the topology table 301 (step S83). The downstream node sends a connection request to the selected upstream node (step S81). If a connection permission notification is received from the upstream node, the connection to the upstream node is completed (YES in step S82).

If a connection rejection notification is received from the selected upstream node, the downstream node selects all upstream node candidates from the topology table 301 and sends connection requests to them (NO (B) in step S82; NO in step S84). If connection rejection notifications are received from all the upstream node candidates, the downstream node receives the introduction of a new upstream node from the node intermediary server (YES in step S84; step S80).

If the downstream node detects a deterioration in the quality of stream data relayed from the connected upstream node (step S73), the downstream node cuts the connection to the upstream node and shifts to processing of selecting another upstream node from the topology table 301 (steps S85 and S83). The subsequent processing is the same as the above processing performed upon detection of an interruption of communication with the upstream node.

(Procedures for Exchanging Topology Information)

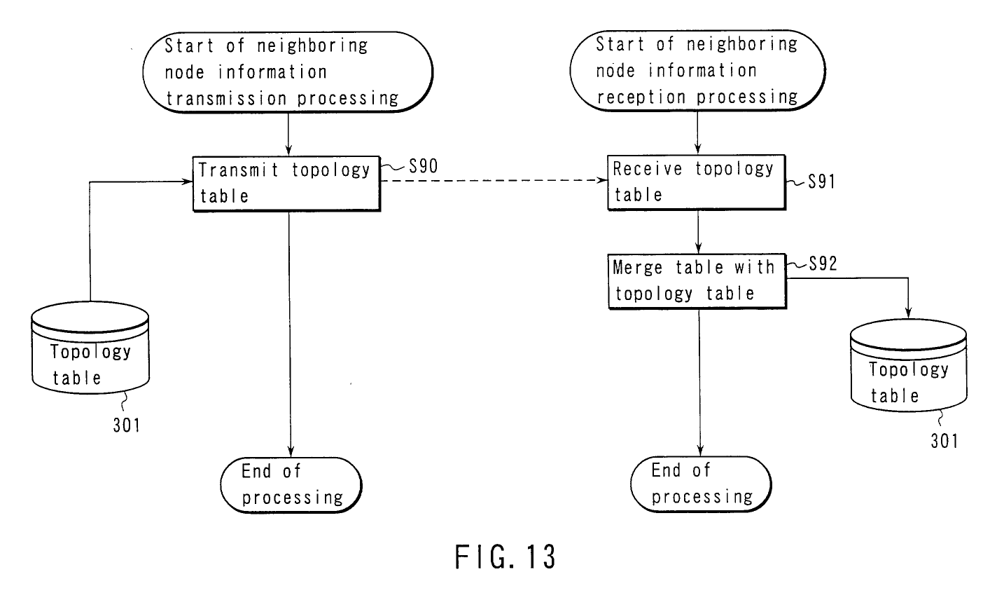

FIG. 13 is a flow chart for systematically explaining procedures for exchanging topology information between the respective nodes.

As described above, in the topology engine 30 of each node, the topology management section 300, topology table 301, and control data communicating sections 303 and 304 exchange a topology information table (TI).

Assume that an upstream node transmits topology information table (TI) to a downstream node. The upstream node transmits, to the connected downstream node, a topology information table indicating the connection relationship between the local node and an adjacent or neighboring node (step S90). Upon reception of the topology information table from the upstream node, the downstream node merges (add) the table with the topology table 301 and stores the resultant data (steps S91 and S92).

As described above, according to this embodiment, in a network environment such as the broadband Internet, in particular, a stream data decentralized distribution system network constituted by upstream and downstream nodes can be formed by connecting the respective nodes by using the function of the topology engine 30 installed in each node. More specifically, as shown in FIG. 1, the stream data transmitted from the uppermost stream node 10A is distributed to the neighboring downstream node 10B. The downstream node 10B plays back the received stream data by decoding it, and at the same time, relays the stream data to a downstream node. Likewise, each downstream node decodes/plays back the received stream data, and relays, serving as an upstream node, the data to a downstream node. In general, however, each node connects to the Internet through an ISP (Internet Service Provider), communication company, or the like.

Even if, therefore, no stream data distribution server exists, a stream data distribution system network constituted by only clients (user terminals) can be realized. By using such a decentralized network forming function, even in a network designed to distribute stream data from a stream data distribution server, the load for distribution processing imposed on the server can be reduced. That is, while stream data is distributed from a server managed by, for example, a broadcasting company to each user terminal, the stream data can be distributed from each user terminal to each of other user terminals. This makes it possible to reduce the load on the server managed by the broadcasting company independently of the number of user terminals as stream data destinations.

In addition, instead of a so-called business stream data distribution system network, a private network can be constructed which is designed to distribute private pictures (including video and audio) taken by a user and the like to only the nodes of persons interested who have connected to the Internet. The use of such a private network can provide a service that can also be called personal broadcasting.

Note that this embodiment has been described on an assumption that the node intermediary server is present. This node intermediary server totally differs from a central control server of a decentralized distribution system, and is a server having only a limited function of introducing a candidate as an upstream node. This server therefore does not require a database like that accurately recognizes all nodes constituting a network, and it does not matter whether an unknown node exists among the nodes joining in the network. As is obvious, if the user knows an upstream node by a method other than the method of making the node intermediary server introduce an upstream node, the node intermediary server is not required. That is, in this embodiment, the node intermediary server is not an indispensable constituent element but is a desired server in terms of practical service efficiency.

(Business Model or Application Example Applicable to Embodiment)

With the application of the stream data decentralized distribution system network according to this embodiment, the following business models or application examples can be realized.

(1) A system so-called a personal broadcasting or community broadcasting system can be realized, which distributes personal pictures (including video and audio) taken by a user in, for example, a wedding reception, as stream data, to users (only persons concerned). In this case, each node constituting a network is formed from only a user terminal specified by a connection authentication function based on, for example, a public key scheme.

(2) A video chat service can be realized as an improved system of the system (1) by allowing a group of users, each having a video camera, to simultaneously transmit/receive data among them.

(3) A business model which can also be called a location service can be realized, in which a node having a video camera is installed in a specific outdoor place such as a street, a building, a concert hall, or the like, and a video (with sound) taken by the video camera at the occurrence of an incident or event is relayed to each node that has made a contract and received a connection key. In this case, each node can connect to the network managed by a service company and receive a relay service by making a contact with the company. More specifically, so-called Internet concert live broadcasting can be easily realized.

(4) In a commercial distribution service system network for contents, when pay contents are to be distributed from the server managed by a company to users, the distribution load on the server can be reduced by making each user provide a relay node. In this case, if a user who provides a relay node is given an incentive like providing a point that can be exchanged with a viewing ticket for the contents, the system of this embodiment can be effectively used.

(5) Various communication services can be realized as well as stream data distribution services by connecting nodes through peer-to-peer communication including information communication from downstream nodes to upstream nodes using control data communication channels between the nodes. For example, by aggregating information from downstream to upstream, a popularity poll service on distributed contents and real-time services for quizzes and questionnaires can be provided. In this case as well, there is no need to use a large-capacity server for handling simultaneous accesses. In addition, communication like chatting between downstream nodes can be realized at the same time with stream data distribution. For example, a service of allowing viewers to chat with each other while watching a concert broadcast can be provided.

As described in detail above, according to this embodiment, in a network environment such as the Internet, an autonomous or private data distribution system for distributing stream data and the like among user terminals, in particular, can be realized. More specifically, decentralized distribution of stream data such as moving image and audio data between clients (terminal nodes) can be realized by using, for example, a broadband network environment without preparing any special stream data distribution server.

A characteristic feature of this embodiment is that each node (user terminal) performs decentralized management of topology information for recognizing the network connection relationship between the respective user terminals. In other words, each node has the function of autonomously storing, updating, providing topology information. This makes it possible to perform transmission, reception, and relaying of stream data among the user terminals connected to, for example, the Internet without requiring any stream data distribution server managed by a service company, decentralized distribution system control server, and the like.

As a specific application example of this embodiment, a service that can be called a personal broadcasting service can be realized, which distributes private pictures (including video and audio) taken by a general user to only persons concerned by using personal computers and the like connected to the Internet. In addition, a user or company can realize a so-called Internet broadcasting service of relay broadcasting lives and concerts to many viewers.

(Second Embodiment)

This embodiment relates to an authentication method which is effective for the above data distribution system and, more particularly, to a method of decentralizing the authentication function between a plurality of nodes.

This method is an authentication method which implements the authentication function between a plurality of nodes connected to a computer network and uses public key cryptography using a combination of encryption key data and decryption key data.

This embodiment will be described in detail below with reference to the accompanying drawings.

(Arrangement of System)

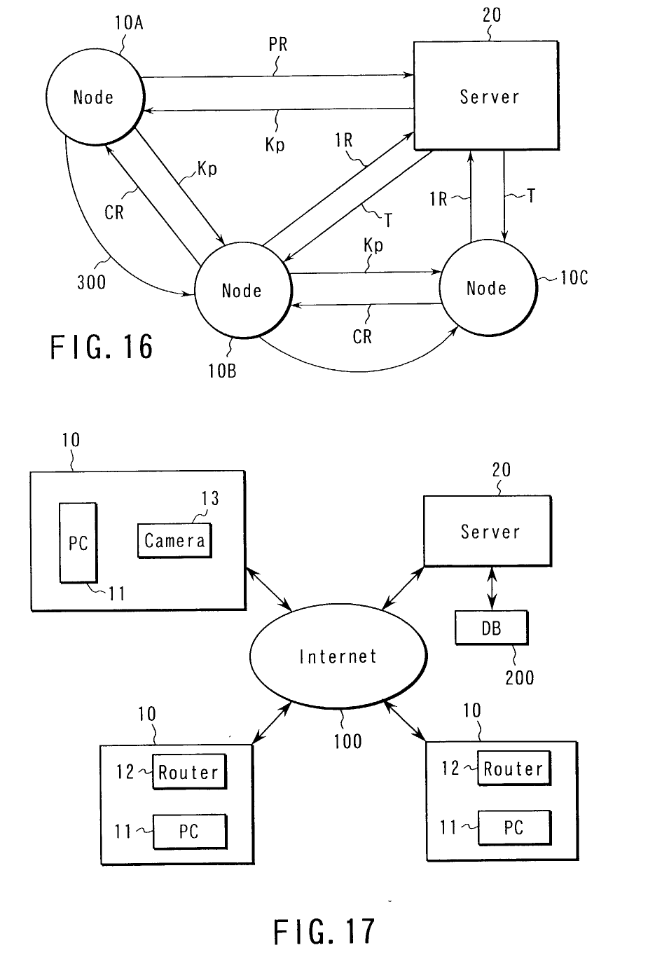

FIG. 16 is a view showing the concept of a data (stream data) distribution system according to this embodiment. This system is formed in consideration of a computer network environment such as the broadband Internet, in particular, and designed to distribute, for example, stream data through a plurality of nodes 10 connected to the network. In this case, “stream data” means continuous digital data including contents information such as moving image (video) data and audio data.

An upstream node 10A means one of the nodes 10 connected to the Internet which serves as a data distribution source node and is located at the uppermost stream position. This upstream node 10A distributes data (stream data) 300 including contents information such as video or audio information. A node 10B is connected to the upstream (distribution source) node 10A and functions both as a downstream node for receiving the data 300 and a relay node functioning as an upstream node. This relay node 10B executes relay processing of transmitting the data (stream data) 300 received from the upstream node 10A to a downstream node 10C which requires distribution. Assume in this case that the downstream node 10C only executes the processing of receiving and playing back distributed data but does not function as a relay node.

As a key distribution server 20, a server managed by, for example, a service provider is assumed. In this case, this service provider provides various key data required for authentication processing for each node in decentralized distribution of the contents information (identified by ID information) on the basis of a contract with the user who operates the upstream (distribution source) node 10A. Note that the key distribution function of the server 20 may be implemented by a server function set in the node operated by a user.

In brief, according to this system, for example, the upstream node 10A serving as a distribution source transmits stream data to the node 10B relatively serving as an downstream node. The node 10B operates as an upstream node relative to other downstream nodes 10. The node 10B plays back (i.e., allows the user to watch and listen to) the received stream data, and relays the data to other downstream nodes 10. In this case, the node 10B relays the stream data to a plurality of downstream nodes within the allowable load.

In this system, each node 10 connected to the Internet operates as an upstream or downstream node, and stream data is relayed from an upstream node to downstream nodes. This system can implement a data decentralized distribution function by using, for example, a low-cost personal computer without using any high-performance data distribution server. In this case, the upstream node means a node which is located upstream from the local node and serves as a stream data source node (distribution source node) or relay node. The downstream node means a stream data destination node when viewed from the local node. The downstream node can function as a reception node for receiving stream data or a relay node for sending stream data to a downstream node.

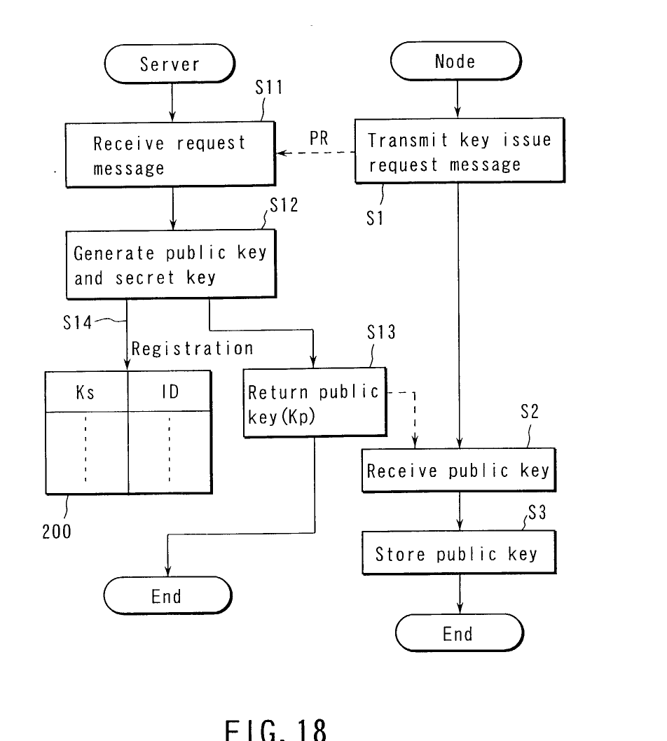

FIG. 17 is a block diagram showing an example of the specific arrangement of this system.

This system is based on a specific assumption that many nodes 10 as user terminals and the server 20 (a kind of node) (to be described later) are connected to an Internet 100, and stream data are distributed to user terminals joining in a stream data decentralized distribution system through the Internet 100.

Each node 10 is assumed to be used in an environment in which the node is connected to the Internet through an always-on connection type high-speed line by using, for example, an ADSL transmission scheme, CATV network, or a mobile communication scheme (radio communication scheme) such as a scheme using cellar telephones.

A given node 10 is a user terminal having, for example, a personal computer (PC) 11 and router 12. This node 10 plays back the stream data received through the Internet 100 on, for example, the display of the PC 11, and also relays the data to other downstream nodes 10. Another node 10 has, for example, the PC 11 and a digital video camera (DVC) 13. This node is a user terminal which serves as an upstream node and sends out the stream data formed from video data (including audio data) obtained by the DVC 13 by using software (a main constituent element of this embodiment) set in the PC 11.

(Arrangement of Node)

The node 10 in this embodiment is comprised of a computer (microprocessor) and software set in the computer. In this case, the respective nodes 10 have the same software configuration and implement stream data transmission, reception, relay, and playback functions and an authentication function. Note that the specifications of the software configuration in this embodiment do not depend on any specific OS (operating system).

This software configuration mainly has a functional section for implementing the function of forming a network connection form (topology) as a logical connection relationship between the respective nodes 10 by exchanging messages (control information), a functional section for implementing stream data transmission (including relay), reception, and playback functions, a functional section for implementing a GUI (graphical user interface) function as an input/output interface with a user, and an authentication functional section.

In this embodiment, as the server 20, a key distribution server is assumed which is managed by, for example, a service provider so as to distribute key data necessary for authentication processing for each node. As will be described later, the server 20 provides key data by a public key encryption scheme. Each node 10 executes authentication processing, by using the key data provided from the server 20, for a downstream node which generates a connection request.

(Procedure for Issuing Public Key)

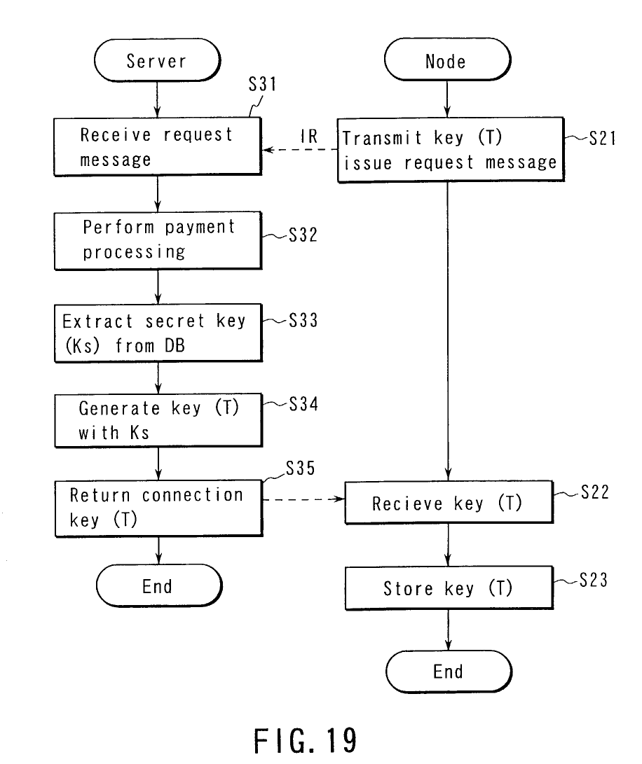

The authentication method in this embodiment implements an authentication function using key data based on public key cryptography. A key data issuing procedure executed by the server 20 will be described below by mainly referring to the flow charts of FIGS. 18 and 19.

First of all, before distribution of the data 300, the upstream node (distribution source) 10A requests the sever 20 to issue key data for authenticating a downstream node as a proper destination. More specifically, as shown in FIG. 18, the upstream node 10A transmits a key issue request message (PR) to the server 20 (step S1). In this case, the message (PR) contains, for example, ID information (contents ID) for identifying contents information to be distributed and a password for identifying the distribution source node 10A.

As shown in FIG. 18, upon reception of the key issue request message (PR) from the distribution source node 10A, the server 20 authenticates on the basis of the password contained in the message (PR) whether the node is a proper upstream node defined by the contract that has been made. If the server 20 authenticates the node as a proper upstream node, the server generates key data constituted by a pair of public key data (Kp) and secret key data (Ks) (steps S11 and S12). That is, the server 20 generates public key data (Kp) and secret key data (Ks) corresponding to the contents ID contained in the message (PR).

The server 20 registers the generated secret key data (Ks) in a secret key database 200 while associating the data with the contents ID (step S14). The server 20 also returns a response message containing the generated public key data (Kp) to the distribution source node 10A (step S13).

Upon reception of the response message from the server 20, the distribution source node 10A stores the public key data (Kp) contained in the message in an internal storage device (e.g., a disk drive) while associating the data with the contents ID (steps S2 and S3).

In the above manner, the distribution source node 10A can acquire the public key data (Kp) necessary for authentication processing from the server 20 before distributing the data 300 such as stream data. The distribution source node 10A executes authentication processing by using the public key data (Kp) to check whether the node which has sent a connection request to the local node is a proper node in the manner described later. In this case, a node authenticated as a proper node is, for example, a node which has acquired connection authentication key data (T) from the server 20 in making a payment for data distribution.

As will be described later, connection authentication key data (T) is key data encrypted with secret key data (Ks). Public key data (Kp) is key data for decrypting the connection authentication key data (T). That is, secret key data (Ks) and public key data (Kp) correspond to encryption key data and decryption key data, respectively.

(Procedure for Issuing Connection Key)

The downstream node 10B sends a connection request to the distribution source node 10A and receives a data distribution service such as a stream data distribution service. The downstream node 10B requests the server 20 to issue a connection key for connecting to the distribution source node 10A. More specifically, as shown in FIG. 19, the downstream node 10B transmits a connection key issue request message (IR) to the server 20 (step S21). In this case, the message (IR) contains, for example, a contents ID (G) for identifying contents information to be distributed and node identification information (H) for identifying the node 10B. The node identification information (H) is, for example, the MAC address of a network (Ethernet or the like) used by the node 10B or the identification number of hardware, e.g., the serial number of the microprocessor.

As shown in FIG. 19, upon reception of the issue request message (IR) from the node 10B, the server 20 executes payment processing for a charge for a stream data distribution service (steps S31 and S32). In this payment processing, for example, the server 20 displays the charge on the display screen on the node 10B side and prompts the user to input a credit card number. When a credit card number is input from the node 10B, the server 20 executes predetermined payment processing to withdraw the charge from the credit card account.

In this case, the service provider which manages the server 20 executes payment processing for the charge to provide key data necessary for authentication processing in decentralized distribution of the contents information (identified by the ID information) on the basis of the contract with the user who operates the upstream (distribution source) node 10A. In brief, the server 20 performs a kind of agency business for storage and handling of key data necessary for authentication processing on the basis of the contract with the user who operates the upstream (distribution source) node 10A.

Subsequently, the server 20 extracts secret key data (Ks) corresponding to a contents ID (G) from the secret key database 200 (step S33). The server 20 generates connection authentication key data (T) by encrypting the contents ID (G) and node identification information (H) by using the extracted secret key data (Ks) (step S34). The server 20 returns a response message containing the generated connection authentication key data (T) to the downstream node 10B (step S35). That is, the server 20 stores the secret key data (Ks) as encryption key data.

Upon reception of the response message from the server 20, the downstream node 10B stores the connection authentication key data (T) contained in the message in an internal storage device (e.g., a disk drive) (steps S22 and S23).

In the above manner, the downstream node 10B can acquire the connection authentication key data (T) from the server 20 in performing payment processing for the charge for the stream data distribution service. The server 20 pays the user of the distribution source node 10A the charge based on the contract. More specifically, for example, the company which manages the server 20 subtracts a predetermined commission from the charge paid by the end user of the node 10B and transfers the balance to the account of the user of the distribution source node 10A. In this case, the user of the distribution source node 10A corresponds to the owner of contents information or contents distribution service company.

(Procedure for Authentication Using Connection Key)

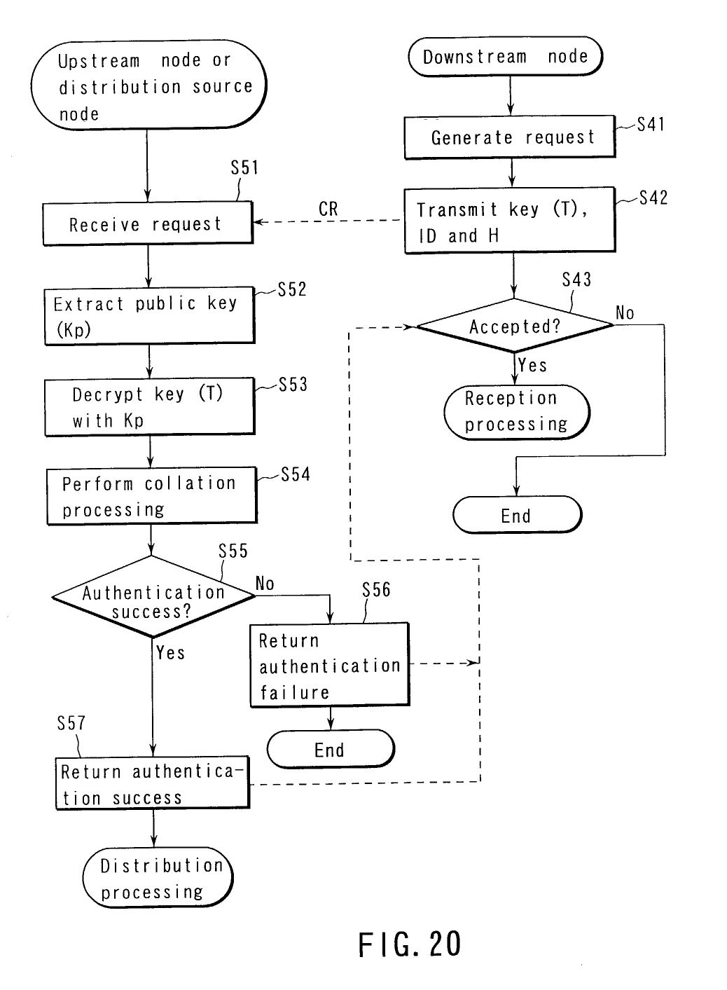

As shown in FIG. 20A, the downstream node 10B transmits a connection request message (CR) for receiving the distribution of stream data to the distribution source node 10A to request the data distribution. The downstream node 10B makes the connection request message (CR) contain connection authentication key data (T), a contents ID (G) for identifying a stream content, and node identification information (H) for identifying the node 10B (steps S41, S42). In this case, as described above, the connection authentication key data (T) is data encrypted by the secret key data (Ks) stored in the server 20. The contents ID (G) and node identification information (H) are plain text data that are not encrypted.

As shown in FIG. 20, upon reception of the connection request message (CR) from the downstream node 10B, the distribution source node 10A extracts the public key data (Kp) corresponding to the contents ID (G) from the internal storage device (steps S51 and S52). The distribution source node 10A reconstructs the contents ID (G) and node identification information (H) by decrypting the connection authentication key data (T) by using the extracted public key data (Kp) (step S53). That is, the server 20 provides public key data (Kp) as decryption key data.

The distribution source node 10A then collates the contents ID (G) and node identification information (H) reconstructed from the connection authentication key data (T) with the contents ID (G) and node identification information (H) received as plain text data from the downstream node 10B (step S54). If this collation result exhibits coincidence, the distribution source node 10A determines that the authentication has succeeded and the downstream node 10B which has sent the connection request is a proper node (a user who has paid the charge) (YES in step S55). In the case of an authentication success, the distribution source node 10A sends out (provides) predetermined stream data to the downstream node 10B who has sent the connection request.

If authentication is made, i.e., the connection request is accepted, the downstream node 10B receives the stream data sent out from the distribution source node 10A, and executes processing like playing back the data on the display screen (YES in step S43).

In the case of an authentication failure, the distribution source node 10A returns a message to notify the authentication failure to the downstream node 10B (NO in step S55; step S56). The downstream node 10B then terminates the processing because the connection request is not accepted (NO in step S43). In this case, fraud connection authentication key data may be used or authentication processing error or the like may have occurred. For this reason, the downstream node 10B executes the above processing again or acquires connection authentication key data from the server 20 again.

In the above manner, the distribution source node 10A uses the public key data (Kp) acquired in advance from the server 20 to authenticate whether the downstream node 10B which has requested a data distribution service is a proper user. If the downstream node 10B has acquired the connection authentication key data (T) issued upon payment of the charge, the node 10B is authenticated as a proper node. In this case, the node 10B can receive a desired contents information (stream data in this case) provision service.

(Procedure for Relay Processing)

In this embodiment, each node 10 (including 10A and 10B) connected to the network has the function of relaying the data (stream data) received from another upstream node to other downstream nodes. As shown in FIG. 16, therefore, the downstream node (relay node) 10B, to which a data distribution service is provided from the distribution source node 10A, relays, serving as an upstream node, the received stream data in accordance with a request from another downstream node 10C.

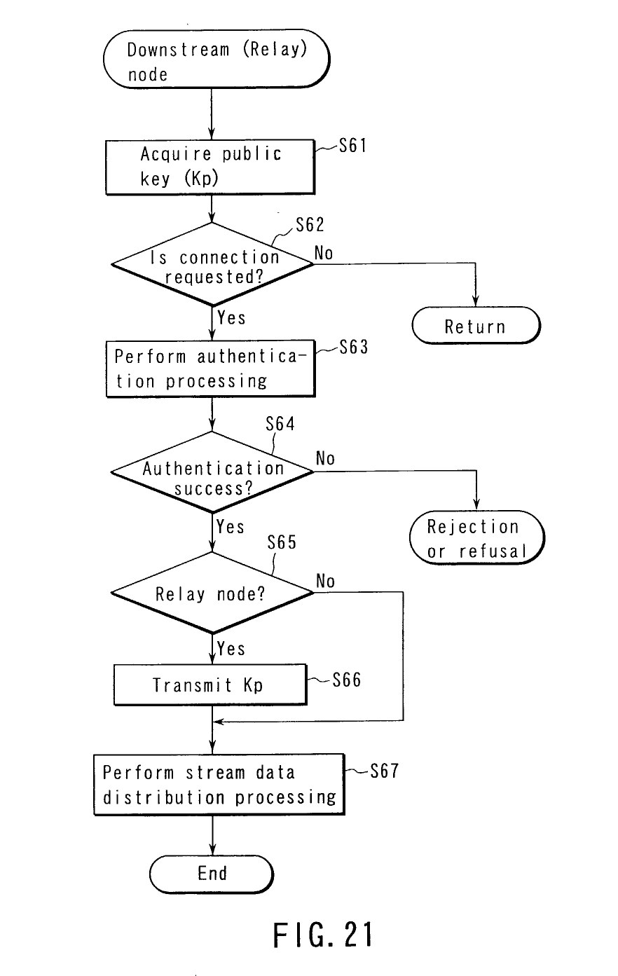

In such data relay operation as well, the node 10B can authenticate by the authentication function in this embodiment whether the destination node 10C is a proper node. This operation will be described below with reference to the flow chart of FIG. 21.

The relay node 10B which executes data relay processing receives public key data (Kp) from the distribution source node 10A (step S61). The relay node 10B stores the acquired public key data (Kp) in an internal storage device (e.g., a disk drive) while associating the data with a contents ID.

Upon reception of a connection request message (CR) from the downstream node 10C, the relay node 10B extracts the public key data (Kp) from the internal storage device and executes the above authentication processing (step S63). More specifically, the downstream node 10C acquires connection authentication key data (T) in advance from the server 20 in performing payment processing for the charge for a stream data distribution service. The relay node 10B reconstructs the contents ID (G) and node identification information (H) by decrypting the connection authentication key data (T) transmitted from the downstream node 10C by using the extracted public key data (Kp). The relay node 10B then collates the contents ID (G) and node identification information (H) reconstructed from the connection authentication key data (T) with the contents ID (G) and node identification information (H) received as plain text data from the downstream node 10C.

If this collation result exhibits coincidence, the relay node 10B determines that the authentication has succeeded and the downstream node 10C which has sent the connection request is a proper node (a user who has paid the charge) (YES in step S64). In the case of an authentication failure, the relay node 10B notifies the downstream node 10C that the connection request (stream data distribution request) cannot be accepted (NO in step S64).

If the downstream node 10C authenticated as a proper node can operate as a relay node, the relay node 10B may provide the above public key data (Kp) (steps S65 and S66). In the case of the authentication success, the relay node 10B sends out (provides) predetermined stream data to the downstream node 10C which has sent the connection request (step S67).

With this stream data relay processing, the distribution source node 10A can implement an indirect stream data distribution function by using a downstream node (10B) as a relay node without sending out the stream data to all the downstream nodes 10 which request stream data distribution. This makes it possible to greatly reduce the load associated with stream data distribution by the distribution source node 10A. In this case, by using the authentication function in this embodiment, the relay node 10B can authenticate, like the distribution source node 10A, whether the downstream node 10C which has requested a stream data distribution service is a proper node (a user who has paid the charge).

(Procedure for Erasing Key Data)

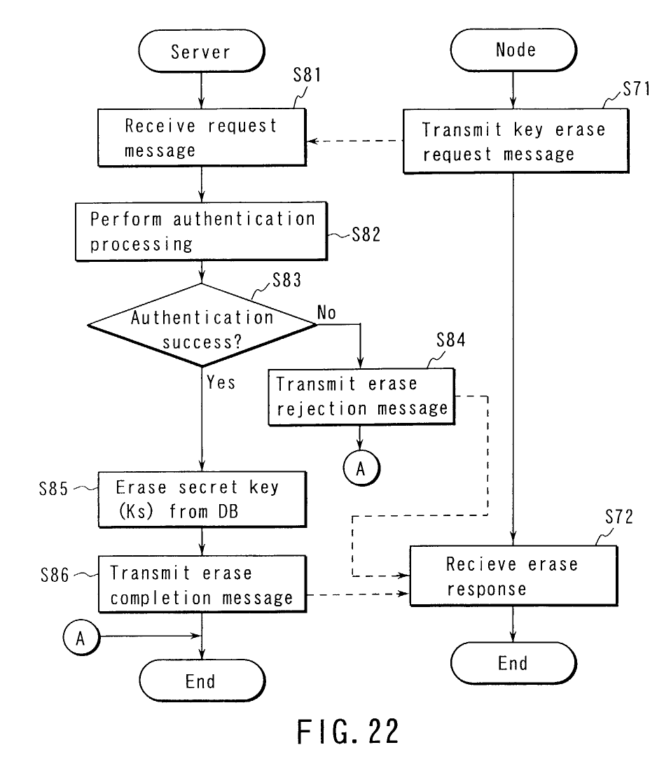

In this embodiment, the distribution source 10A requests the server 20 to issue key data necessary for an authentication function so as to acquire public key data (Kp) before performing stream data distribution. This key data (Kp) is paired with secret key data (Ks) and associated with a stream content identified by ID information) to be distributed. Therefore, in order to stop the distribution of the stream content and invalidate the key data (Kp and Ks), a procedure for erasing the secret key data (Ks) issued by the server 20 from the registration area in accordance with a request from, for example, the distribution source 10A, thereby invalidating the key data (Kp and Ks) must be prepared. A procedure for erasing key data will be described below with reference to the flow chart of FIG. 22.

As shown in FIG. 22, the distribution source 10A transmits a key erase request message to the server 20 (step S71). This message contains a contents ID for identifying a stream content to be distributed and a password for authenticating the request as a request from the distribution source 10A.

As shown in FIG. 22, upon reception of the key erase request message from the distribution source 10A, the server 20 executes authentication processing on the basis of the pre-registered contents ID and password to check whether the distribution source 10A is a proper node (steps S81 and S82). If the authentication fails, the server 20 determines that the node 10A is not a proper node, and transmits an erase rejection message to the request source 10A (NO in step S83; step S84).

If the authentication succeeds, the server 20 specifies secret key data (Ks) corresponding to the contents ID from the secret key database 200, and erases the key data from the registration area (YES in step S83; step S85). Upon completion of the erase processing, the server 20 returns an erase completion message to the distribution source 10A (step S86).

Upon reception of the erase completion message from the server 20, the distribution source 10A may erase public key data (Kp) corresponding to the secret key data (Ks) from an internal storage device (e.g., a disk drive) (step S72).

As described above, in stopping the service of distributing a predetermined stream content and invalidating key data (Kp and Ks), the distribution source 10A can erase the secret key data (Ks) issued by the server 20 from the registration area. The distribution source 10A can therefore invalidate the key data (Kp and Ks) constituted by the pair of secret key data (Ks) and public key data (Kp) associated with the stream content.

(Effect Concerning Security)

According to the authentication method of this embodiment, since a contents ID (G) and node identification information (H) are plain text data, the third party can easily acquire them. However, connection authentication key data (T) is encrypted with secret key data (encryption key data) (Ks) stored in the server 20. It is therefore difficult for the third party to generate proper connection authentication key data (T). In other words, the authentication method of this embodiment can ensure that only the server 20 (or a specific user terminal) which stores secret key data (Ks) can issue proper connection authentication key data (T).

In addition, public key data (Kp) and connection authentication key data (T) are stored in a user terminal, and hence may leak to the third party. According to public key cryptography, however, it is generally difficult to calculate secret key data (Ks) from a combination of public key data (Kp) and connection authentication key data (T). In this case, limiting the period (or time) in which effective connection authentication key data (T) is distributed will prevent an unauthorized user from counterfeiting connection authentication key data (T).

Furthermore, proper connection authentication key data (T) is made valid only in the form of a combination of a contents ID (G) and node identification information (H). Therefore, a downstream node different from a proper downstream node is not authenticated and cannot receive data distributed. Even a proper downstream node cannot receive contents information other than the corresponding contents information.

(Business Model to Which Embodiment is Applied)

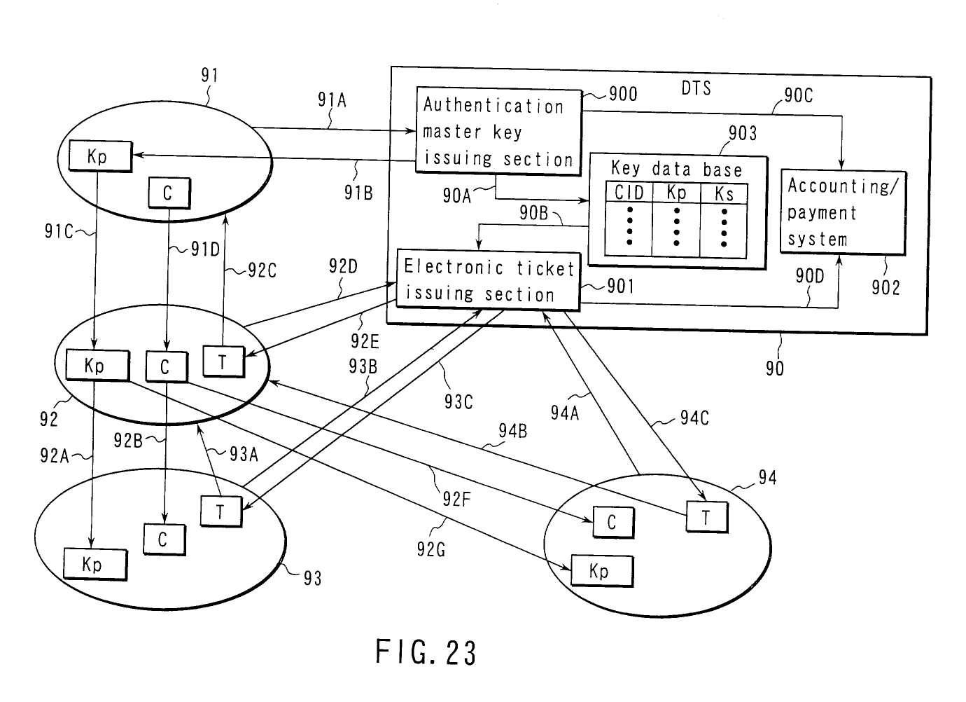

A specific example of a business model to which this embodiment is applied will be described below with reference to FIG. 23.

This business model is formed in consideration of a service business of decentralized distribution of digital contents to many users on the broadband (broadband always-on connection type) Internet, in particular.

More specifically, a contents distribution service is assumed, which is provided by a company which manages an electronic ticket distribution service (to be referred to as TSP: Ticket Service Provider) and a company which provides a service of distributing contents on the basis of electronic tickets (to be referred to as a CSP: Contents Service Provider). A user (i.e., a general consumer) can receive the distribution of a desired content from the CSP by purchasing an electronic ticket from the TSP.

In this case, the electronic ticket corresponds to connection authentication key data (T) in this embodiment. In this model, an authentication master key (to be referred to as master key data hereinafter) is used to authenticate an electronic ticket. This master key data corresponds to decryption key data (public key data) in this embodiment.

FIG. 23 shows a mechanism for realizing a contents distribution service. Assume in this case that a server (to be referred to as a DTS: Digital Ticket Server hereinafter) 90 and a plurality of nodes 91 to 94 are always connected to the Internet. The node 91 corresponding to the upstream node is a contents distribution node (to be referred to as a distribution source node hereinafter) managed by the CSP. The respective nodes 92 to 94 corresponding to relay or downstream nodes are personal computers (including portable information terminals such as PDAs) possessed and operated by general users. The DTS is managed by the TSP which distributes electronic tickets.

The distribution source node 91 receives master key data (Kp) as authentication information required for contents distribution from the DTS 90. The CSP (contents distribution node 91) receives a value equivalent to contents distribution from the TSP (DTS 90). The TSP collects part of transaction amounts between the CSP and the users (nodes 92 to 94) as a commission. Each user pays the TSP for an electronic ticket fee as a charge for contents distribution.

(Procedure for Preparing for Issuing Electronic Ticket)

In a procedure for preparing for issuing, the CSP (distribution source node 91) requests the DTS 90 to issue master key data (Kp) in association with a content to be distributed to users (process 91A). Upon reception of this request, an authentication master key issuing functional section 900 of the DTS 90 generates contents identification information (CID: Contents ID, e.g., a unique number) and a key pair of encryption key data (Ks) and decryption key data (Kp) (corresponding to a secret key and public key in public key cryptography). A combination of these three data is registered in a key database 903 (process 90A). The DTS 90 returns the decryption key data (Kp) as master key data to the CSP (distribution source node 91) (process 91B).

In this case, the TSP (DTS 90) charges the CSP (distribution source node 91) a commission upon registering the data in the key database 903 and returning the master key data (Kp). More specifically, online payment processing such as withdrawal from the bank account of the CSP is executed in cooperation with an accounting/payment system 902 connected to the DTS 90. That is, a process 90C is charge accounting/payment processing to be done upon issuing of master key data (Kp).

When the above preparation is completed, the CSP (distribution source node 91) does an advertisement or the like for the content distribution service to general users through a WWW homepage (Web page), electronic mail, or a paper medium such as a magazine on the Internet. In this case, a CID for specifying the content is generally presented.

(Procedure for Issuing Electronic Ticket)

A procedure of issuing an electronic ticket in a contents distribution service will be described next.

In this case, of the nodes 92 to 94 operated by the users who want to receive the distribution of the contents, the node 92 will be referred to as a relay node, and the remaining nodes will be referred to as user nodes, for the sake of convenience. The relay node 92 functions as a user node and has the function of relaying contents from the distribution source node 91 to the respective user nodes 93 and 94.

Each of the users (relay node 92 and user nodes 93 and 94) who want to receive the distribution of the contents generally acquires the CID from the advertisement (Web page or the like) made by the CSP (distribution source node 91). Each of the users (nodes 92 to 94) transmits an electronic ticket issue request including the CID and identification information UID to the DTS 90 (processes 92D, 93B, and 94A). The UID is so-called node identification information and, more specifically, the hardware identification of a personal computer used by a user and the like. The information constituted by a combination of CID and UID is authentication information that can specify that the user can receive the distribution of the contents.

Upon reception of the electronic ticket issue request, an electronic ticket issuing functional section 901 of the DTS 90 extracts encryption key data (Ks) corresponding to the CID from the key database 903 (process 90B). The electronic ticket issuing functional section 901 then encrypts authentication information including the CID and UID by using this encryption key data (Ks). This encrypted data which is generated as an electronic ticket (connection authentication key data T), is sent to the respective users (nodes 92 to 94 (processes 92E, 93C, and 94C) as response.

According to this electronic ticket issuing method, it is difficult for a user to illicitly generate (counterfeit) an electronic ticket (T). This is because encryption key data (secret key data Ks) necessary for the generation of an electronic ticket (T) exists only in the DTS 90 and concealed therein.

An electronic ticket (T) is data containing encrypted UID which is information unique to a user. Therefore, tickets corresponding to the same content (CID) are formed from different data (bit strings) for the respective users (i.e., the nodes). For this reason, even if a given user tries to request the content by stealing an electronic ticket of another user and using a different personal computer (node), the stolen electronic ticket can be detected in the process of the connection authentication for the ticket.

With regards to issuing of an electronic ticket, the TSP (distribution source node 91) charges the user a fee for issuing the electronic ticket (i.e., the distribution of the content). More specifically, online payment processing of adding the amount obtained by subtracting the commission for the issuing of the electronic ticket from the charge to the bank account of the CSP is executed (process 90D for charge accounting). In this case, the accounting/payment system 902 generally performs payment with a user's credit card number input at the time of the reception of an electronic ticket issue request.

(Procedure for Contents Distribution)

In the above manner, the CSP (distribution source node 91) acquires master key data (Kp), and each of the users (nodes 92 to 94) acquires an electronic ticket (T). A procedure for decentralized distribution of contents will be described in consideration of such a situation.

For the sake of convenience, assume that the user node 92 also serving as a relay node sends a distribution request for a content (C) to the distribution source node 91 (process 92C). In this case, the relay node 92 transmits authentication information containing an electronic ticket (T) and CID and UID which are plain text data.

The CSP (distribution source node 91) decrypts the received electronic ticket (T) with master key data (Kp) to extract the CID and UID as pieces of authentication information. The distribution source node 91 then collates the decrypted authentication information with the plain text authentication information (CID and UID). If they coincide with each other, the distribution source node 91 determines that the relay node 92 is a proper user node. In other words, the distribution source node 91 determines that the electronic ticket (T) from the user is a proper ticket acquired from the DTS 90 by an authorized procedure.

With this authentication processing, the content (C) corresponding to the electronic ticket (T) is transmitted to the proper user node (relay node 92) (process 91D). In this case, if master key data (Kp) is requested by the user node which has succeeded in authentication, the CSP (distribution source node 91) may provide the master key data (Kp) together with the content (C) (process 91C).

In brief, the user node 92 functioning as a relay node uses the received content (C) by itself, and distributes (relays) the content (C) to the remaining user nodes 93 and 94 in place of the CSP (processes 92B and 92F). At this time, as described above, the relay node 92, like the CSP (distribution source node 91), obtains the right (so-called logical right) to authenticate the remaining user nodes 93 and 94 by acquiring the master key data (Kp). More specifically, the relay node 92 executes the same authentication processing as that described above upon reception of electronic tickets (T) from the remaining user nodes 93 and 94 which request content distribution (processes 93A and 94B).

In addition, the relay node 92 relays the master key data (Kp) to the user nodes 93 and 94 from which the requests have been received, together with the content (92A,92G). Therefore, each of the user nodes 93 and 94 can function as a relay node as well as a user who simply uses the content.

As described above, the mechanism for the contents distribution service of distributing contents on the basis of issuing of electronic tickets can be realized. This mechanism can realize decentralized distribution of contents in mutual cooperation with many user nodes as well as distributing contents from the distribution source node 91 to a plurality of user nodes 92 to 94. Decentralizing the authentication function accompanying contents distribution among the respective user nodes can prevent centralization of access associated with authentication processing.

Consequently, a contents distribution tree having the distribution source node 91 on the top can be formed and grown scalably limitlessly. This makes it possible to realize a service of distributing contents to many user nodes without requiring each node to have high performance. In addition, this decentralized distribution service is also effective for the distribution of stream data such as live audio and video data as well as simple contents distribution of files and the like.

As described above, according to this embodiment, the authentication function associated with connection between a plurality of nodes, which uses the public key encryption scheme, can be decentralized among the respective nodes without concentrating the load on a specific server in a computer network environment such as the Internet. This can therefore realize a business model to which the data distribution system including the effective authentication function is applied.

More specifically, when distribution of, for example, stream data among nodes can be realized, the authentication function applied to the data distribution can also be decentralized. When stream data is to be distributed from an upstream node which is a user terminal and serves as a distribution source to relay and downstream nodes, decryption key data can be distributed from the upstream node through the relay node. In addition, the relay node can execute authentication processing with respect to a downstream node which generates a connection request by using the decryption key data acquired from a relatively upstream node (the uppermost stream node or relay node). This makes it possible to realize a data decentralized distribution scheme which can also decentralize the authentication function instead of the scheme in which a specific server performs centralized authentication processing.

Note that a key data providing means generally corresponds to a key distribution server managed by, for example, a service company. The service company distributes decryption key data and connection authentication key data on the basis of a contract with a user who operates an upstream node serving as a distribution source. In this case, the key data providing means may be a storage medium (e.g., a CD-ROM) handled by a specific service company instead of a server. More specifically, the present invention incorporates a mechanism of allowing a specific service company to provide a user who operates each node with a storage medium storing decryption key data or connection authentication key data.

What is claimed is:

1. A method of distributing data between nodes in a network constructed by mutually connecting the nodes,
each of the nodes including topology management means for managing topology information for recognizing a connection relationship between an upstream node and a downstream node, means for exchanging the topology information between the nodes, and transmission/reception means for the stream data, the method comprising the steps of:
executing connection between the upstream node and the downstream node;
exchanging the topology information between the upstream node and the downstream node which are connected to each other; and
transmitting the stream data to a downstream node recognized on the basis of the topology information when serving as an upstream node.

2. A method according to claim 1, wherein the topology management means includes
means for registering the topology information including identification information of an upstream node or downstream node which is used to recognize a connection relationship with a local node,
means for updating the topology information in accordance with a change of the connection relationship, and
means for providing a downstream node with the topology information.

3. A method according to claim 1, further comprising the step of receiving stream data transmitted from an upstream node recognized on the basis of the topology information when serving as a downstream node.

4. A method according to claim 1, further comprising the step of receiving stream data transmitted from an upstream node recognized on the basis of the topology information and transmitting the stream data to a downstream node recognized on the basis of the topology information.

5. A method according to claim 1, further comprising the step of causing the topology management means to update the topology information in accordance with establishment of connection to a new upstream node or downstream node or disconnection from an existing upstream node or downstream node.

6. A method according to claim 1, further comprising the steps of:
cutting connection to an existing upstream node and establishing connection to a new upstream node;
receiving stream data transmitted from an upstream node recognized by the topology information updated by the updating step in accordance with establishment of connection in the connection establishing step; and
when a downstream node recognized by the topology information exists, transmitting the stream data received in the receiving step to the downstream node.

7. A method according to claim 1, further comprising the steps of:
receiving stream data transmitted from a server which distributes stream data and is regarded as an upstream node; and
relaying the stream data received in the receiving step to a downstream node recognized on the basis of the topology information.

8. A method according to claim 1, in a server which registers a plurality of upstream nodes connected to the network and introduces each of the nodes is prepared on the Internet, the method further comprising the steps of:
causing the server to introduce a connectable upstream node to a downstream node;
sending a connection request to the upstream node introduced by the server; and
connecting to the upstream node for which connection is permitted in accordance with the connection request.

9. A method according to claim 8, further comprising the step of registering a local node in the server after the step of connecting to the upstream node.

10. A method according to claim 1, further comprising the steps of:
executing connection authentication processing in accordance with a connection request from a downstream node; and
communicating with the downstream node when the processing result in the connection authentication processing step indicates connection permission.

11. A method according to claim 1, further comprising the step of playing back the received stream data.

12. A computer-readable storage medium comprising:
an instruction for causing a computer to execute transmission/reception of stream data between nodes in a network constructed by connecting the nodes to each other;
an instruction for causing the computer to execute functions of registering, updating, and providing topology information for recognition of a connection relationship between an upstream node and a downstream node;
an instruction for causing the computer to execute connection between an upstream node and a downstream node;
an instruction for causing the computer to exchange the topology information between the upstream node and the downstream node which are connected to each other; and
an instruction for causing the computer to transmit or relay the stream data to a downstream node recognized on the basis of the topology information when operating as an upstream node.

13. A medium according to claim 12, further comprising:
an instruction for causing the computer to receive stream data transmitted from an upstream node recognized on the basis of the topology information when serving as a downstream node; and
an instruction for causing the computer to play back the received stream data.

14. A medium according to claim 12, further comprising an instruction for causing the computer to update the topology information in accordance with establishment of connection to a new upstream node or downstream node or disconnection from an existing upstream node or downstream node.

15. A medium according to claim 12, further comprising:
an instruction for causing the computer to execute connection authentication processing in accordance with a connection request from a downstream node; and
an instruction for causing the computer to communicate with the downstream node when a result of the connection authentication processing indicates connection permission.

16. A system for distributing data between nodes in a network constructed by connecting the nodes to each other, comprising:
means for establishing connection between an upstream node and downstream node or cutting connection therebetween;
means for managing topology information for recognizing a connection relationship between an upstream node and a downstream node;
means for exchanging the topology information between an upstream node and a downstream node which are connected to each other; and
means for transmitting the stream data to a downstream node recognized on the basis of the topology information, when operating as an upstream node.

17. An authentication method of realizing an authentication function between a plurality of nodes connected to a computer network, and using public key cryptography using encryption key data and decryption key data in pairs,
each of the nodes being configured to operate as one of an upstream node which transmits data, a downstream node which received data, and a relay node which is a downstream node and also serves as an upstream node, and
key data providing means for providing the decryption key data to the upstream node, and providing the downstream node or relay node with connection authentication key data obtained by encrypting authentication information containing node identification information for identifying a proper downstream node by using the encryption key data,
the method comprising the steps of:
transmitting the connection authentication key data acquired from the key data providing means by a predetermined procedure to an upstream node as a connection request target;
causing an upstream node to decrypt the connection authentication key data received from a downstream node by using the decryption key data acquired from the key data providing means and execute authentication processing with respect to the downstream node by using authentication information contained in the decrypted connection authentication key data; and
causing a relay node to serve as downstream node and decrypt the connection authentication key data acquired from another downstream node by using the decryption key data acquired from another upstream node, thereby executing authentication processing with respect to said another downstream node by using authentication information contained in the decrypted connection authentication key data.

18. A method according to claim 17, wherein
the key data providing means is formed from a specific node or key distribution server connected to the computer network, and
configured to store the decryption key data as the public key data and the encryption key data as secret key data,
transmit the decryption key data in accordance with a request from the upstream node, and
generate and provide the connection authentication key data obtained by encrypting authentication information containing node identification information of the downstream node by using the encryption key data in accordance with a request from the downstream node.

19. A method according to claim 17, wherein
only a specific upstream node receives the decryption key data from the key data providing means, and
the relay node receives the decryption key data from the specific upstream node and transmits the decryption key data to another relay node relatively serving as a downstream node.

20. A method according to claim 17, wherein each of the downstream node and the relay node acquires the connection authentication key data from the key data providing means by a predetermined procedure including payment processing.

21. A method according to claim 17, wherein
the upstream node or the relay node receives plain text authentication information and the connection authentication key data transmitted from a downstream node in accordance with a connection request from the downstream node, and
determines that the downstream node is a proper downstream node, when a collation result between the plain text authentication information and authentication information decrypted from the connection authentication key data by using the decryption key data acquired from the key data providing means or the upstream node in advance indicates a coincidence.

22. A computer-readable storage medium upon which coded steps are written for a method of executing authentication between a plurality of nodes connected to a computer network by using a public key encryption scheme using decryption key data and encryption key data in pairs,
each of the nodes including a computer which executes the program and being configured to operate as one of an upstream node which transmits data, a downstream node which receives data, and a relay node which is a downstream node and also functions as an upstream node,
wherein the method comprises the steps of:
providing the decryption key data to the upstream node by a predetermined procedure;
providing the downstream node or the relay node with connection authentication key data obtained by encrypting authentication information containing node identification information for identifying a proper downstream node by using the encryption key data;
causing a downstream node to transmit the connection authentication key data acquired by a predetermined procedure to an upstream node as a connection request target;
causing an upstream node to decrypt the connection authentication key data from a downstream node by using the acquired decryption key data;
causing an upstream node to execute authentication processing with respect to the downstream node by using authentication information contained in the decrypted connection authentication key data;
causing a relay node to serve as a downstream node and decrypt the connection authentication key data from another downstream node by using the decryption key data acquired from another upstream node; and
executing authentication processing with respect to said another downstream node by using authentication information contained in the decrypted connection authentication key data.

23. A method of performing contents distribution accompanied by authentication processing between a plurality of nodes connected to a computer network,
each of the nodes being configured to operate as one of a distribution source node which provides a contents distribution service, a user node which receives the contents distribution service, and a relay node functioning as a user node and a contents distribution relay node,
a specific node of the nodes providing the distribution source node with authentication master key data corresponding to the decryption key data by a predetermined procedure in public key cryptography using encryption key data and decryption key data in pairs, and
the specific node including electronic ticket providing means for providing the user node or the relay node with an electronic ticket obtained by encrypting authentication information containing node identification information for identifying a proper node and contents identification information for identifying a content as a distribution target by using the encryption key data by a predetermined procedure in accordance with a request from the user node or the relay node,
the method comprising the steps of:
decrypting the electronic ticket received from the user node or the relay node by using the authentication master key data acquired from the electronic ticket providing means in accordance with a contents distribution request from the user node or the relay node;
executing collation between the authentication information decrypted in the decrypting step and the plain text authentication information received from the user node or the relay node; and
when the collation result in the collating step indicated a coincidence, determining that the user node or the relay node which has generated the distribution request is a proper node, and distributing a content corresponding to the contents identification information contained in the authentication information to the proper node.

24. A method according to claim 23, further comprising:
letting the distribution source node have a function of distributing the authentication master key data to a relay node determined as a proper node in the collating step in accordance with a request; and
causing the relay node to
decrypt the electronic ticket received from the user node by using the authentication master key data acquired from the distribution source node in accordance with a contents distribution request from the user node,
executing collation between the authentication information decrypted in the decrypting step and the plain text authentication information received from the user node, and
when the collation result in the collating step indicates a coincidence, determining that the user node which has generated the distribution request is a proper node, and distributing a contents corresponding to the contents identification information contained in the authentication information and distributed from the distribution source node to the proper node.
